(19) United States
(12) Patent Application Publication
(10) Pub. No.: US 2003/0144885 A1
(43) Pub. Date: Jul. 31, 2003

(54) Medical examination and transcription method, and associated apparatus

(75) Inventor: Ranjan Sachdev, Bethlehem, PA (US)

Correspondence Address: Daniel H. Golub, Morgan, Lewis & Bockius LLP, 1701 Market Street, Philadelphia, PA, 19103-2921, US

(73) Assignee: Exscribe, Inc.

(21) Appl. No.: 10/059,651

(22) Filed: Jan. 29, 2002

(51) Int. Cl. G06F 17/60

(52) U.S. Cl. 705/3

(57) ABSTRACT

A method and associated apparatus for generating a patient record that is compliant with insurance guidelines. The method comprising providing a medical transcription system that includes a plurality of fields that may be filled with either a default value or a non-default value. A template is provided for a doctor to view the default values for each one of the plurality of fields, the default values for each one of the plurality of fields may vary based on an exam level. The non-default values is applied to each one of the plurality of fields where the default value is inappropriate. The non-default values are input into the medical transcription system, and the medical transcription system inputs the default values. The compliant patient record is generated using the medical transcription system. In one aspect, fields in letters can be filled using information applied as the default and/or non-default values.

### FIELD OF THE INVENTION

This invention relates to medical patient records, and more particularly to a documentation and generation system for medical patient records.

### BACKGROUND OF THE INVENTION

It is generally understood that the medical profession is mired in paperwork. The Medicare guidelines, Medicaid guidelines, and other insurance regulations contribute to this paperwork. Doctors often perform a wide variety of operations and treatments on patients. Many of these operations and treatments are exceedingly complex and varied. The Medicare requirements are voluminous and often confusing. Doctors, being human, often find the guidelines and regulations difficult to understand and comply with.

If a doctor performs a more extensive examination than indicated for a particular injury by the Medicare guidelines, Medicare will not pay the doctor for services that fall outside the Medicare guidelines. As such, doctors are often uncertain which procedures and exams are to be performed to comply with the Medicare requirement for any specific injury. Conversely, doctors are often uncertain as to which procedures and examinations will not satisfy the Medicare requirements. Medicare characterizes injuries and medical examinations based on the severity, and location of the injury. Such characterization is quantified as a particular level of a level one to five scale. Suppose a doctor is examining a Medicare level-three ankle exam. The doctor should competently perform all the steps required for the level three exam, and should not be compensated for more. Additionally, the doctor will not satisfy the Medicare requirements for payment if the doctor performs procedures, exams, or operations not approved under the Medicare guidelines.

Using present medical transcription systems, a routine office visit requires ten or more pages of transcribed documents to comply with Medicare guidelines. Doctors using present Medicare forms must dictate, for subsequent typing by a medical transcriptionist, each field as required for the examination. Thus, though the injury might be relatively minor, the doctor has to dictate, and the medical transcriptionist has to type a great deal of information regarding the examination, the injury, and the fields that relate to body parts and aspects where the patient is normal. For example, it might be necessary that the doctor indicate on a form to comply with guidelines that the ankle injury patient is not starving since potential malnourishment or other eating disorders are considered as part of the overall condition of the patient. Since the vast majority of ankle injury patients having level three ankle examinations are not malnourished, the doctors will spend the time dictating such uncommon symptoms as lack of malnourishment and other such uncommon symptoms, into the patient medical record during each exam, and will have to subsequently review the completed patient record for errors or omissions. Completing and reviewing all such fields in medical forms where the patient status is normal takes a staggering amount of doctor's and transcriptionist's time. It would be much preferred if doctors could dictate only those fields that indicate where a patient falls outside of the negative, or normal, values.

Medical transcriptionists must type all the patient records (that are intended to comply with Medicare) that are dictated by the doctors. Much time and effort of many medical transcriptionists is largely devoted to filling in these fields (most of which have one common value for that field for most patients) of medical reports using a computer or typewriter. Since the vast majority of the fields have a similar value for virtually all patients, it can also be assumed that the vast majority of the word processing done by the medical transcriptionists could be eliminated by providing some suitable default value for all fields where a patient's state falls within a normal value. Providing a technique for the automatic input of default data to such fields also would limit the number of errors made by medical transcriptionists in typing such repetitive fields. As such, the patient records prepared by medical transcriptionists would be more uniform, contain less errors, and require less time to complete. It would therefore be desirable to provide a technique by which a large percentage of the fields that many medical transcriptionists input text into have some default value.

Doctors' offices complete, and transmit, a large number of letters associated with medical examinations. Examples of these letters include x-ray reports, medical records, referral letters, and medical treatment synopsis. Each of these letters require considerable doctor and transcriptionist time to prepare. Much of the information associated with these letters includes similar information. Having transcriptionists or secretaries prepare a variety of letters relating to such data leads to the possibility of errors, omissions, and the like in each field.

In one aspect, it would be desirable to indicate to doctors, in the form of a template or a checklist, the types of treatment and/or examinations they can perform and still satisfy Medicare requirements. In another aspect, it would be desirable to limit the doctors time devoted to accurately completing records for examinations or treatments in a manner that the records satisfy Medicare requirements. In another aspect, it would be desirable to reduce the time necessary for medical transcriptionists to complete their tasks of preparing medical records while monitoring, or improving, their accuracy. In yet another aspect, it would be desired to be able to generate letters including information contained in medical records so this information does not have to be input multiple times.

### SUMMARY OF THE INVENTION

The present invention relates to a method and associated apparatus for generating a patient record that is compliant with Medicare and other insurance guidelines. The method comprises providing a medical transcription system that includes a plurality of fields that may be filled in with either a default value or a non-default value. A template is provided so a doctor can view the default value for each one of said plurality of fields. Default value that are applied to each one of said plurality of fields vary based on the exam level. The template also allows for non-default values to be input to each one of said plurality of fields where the default value is inappropriate. The non-default values are manually input into the medical transcription system, whereas the default values are automatically input by the medical transcription system itself. The compliant patient record is generated using the medical transcription system.

### BRIEF DESCRIPTION OF THE DRAWINGS

The accompanying drawings, which are incorporated in and constitute part of this specification, illustrate the presently preferred embodiment of the invention, and, together with the general description given above and the detailed description given below, serve to explain features of the invention.

FIGS. 1A, 1B, and 1C show one embodiment of medical treatment template; FIG. 1A shows a template selection guide portion of the medical treatment template; FIG. 1B shows an exam-level portion of the medical treatment template configured for multiple levels of medical examination; and FIG. 1C shows one embodiment of a default/option portion of the medical treatment template;

FIG. 2 shows a block diagram of one embodiment of medical transcription system;

FIG. 3 shows one embodiment of a method used for examination, billing, and payment utilizing the medical treatment template shown in FIG. 1 and the medical transcription system shown in FIG. 2;

FIG. 4 shows another embodiment of the exam-level portion of the medical treatment template shown in FIG. 1B, in which the exam-level portion is directed to a level 2 examination;

FIG. 5 shows another embodiment of the exam-level portion of the medical treatment template shown in FIG. 1B, in which the exam-level portion is directed to a level 3 examination;

FIG. 6 shows yet another embodiment of the exam-level portion of the medical treatment template shown in FIG. 1B, in which the exam-level portion is directed to a level 4 examination;

FIGS. 7A through 7C show one embodiment of a blank form used by the medical transcription system of FIG. 2;

FIGS. 8A through 8C show another embodiment of a blank form used by the medical transcription system of FIG. 2;

FIGS. 9A through 9C show still another embodiment of a blank form used by the medical transcription system of FIG. 2;

FIGS. 10A through 10B show yet another embodiment of a blank form used by the medical transcription system of FIG. 2;

FIGS. 11A through 11C show another embodiment of a blank form used by the medical transcription system of FIG. 2;

FIGS. 12A through 12C show another embodiment of a blank form used by the medical transcription system of FIG. 2;

FIGS. 13A through 13C show one embodiment of a blank form used by the medical transcription system of FIG. 2;

FIGS. 14A through 14C show one embodiment of a blank form used by the medical transcription system of FIG. 2;

FIGS. 15A through 15C show one embodiment of a blank form used by the medical transcription system of FIG. 2;

FIGS. 16A through 16C show another embodiment of a blank form used by the medical transcription system of FIG. 2;

FIGS. 17A through 17C show yet another embodiment of a blank form used by the medical transcription system of FIG. 2;

FIG. 18 shows one embodiment of blank letter which may be completed using the medical transcription system shown in FIG. 2;

FIG. 19 shows another embodiment of blank letter which may be completed using the medical transcription system shown in FIG. 2; and

FIG. 20 shows yet another embodiment of blank letter which may be completed using the medical transcription system shown in FIG. 2.

Throughout the figures, the same reference numerals and characters are used, unless otherwise stated, to denote like features, elements, components or portions of the illustrated embodiments.

### DETAILED DESCRIPTION OF THE EMBODIMENT

This disclosure relates to providing a combination of a medical treatment template 100 and a medical transcription system 300 that are used to produce medical records that comply with Medicare requirements. It is intended that similar templates and concepts as disclosed herein may also be applied to Medicaid guidelines, other insurance guidelines, or any other medical guidelines for which doctors are compensated based on the level of services they perform. The Medicare guidelines specify the type of exam or treatment that is to be performed (and the time that may be spent) by the examining doctor, for which the doctor is to be compensated. Completing a medical patient record that complies with the appropriate Medicare guidelines is challenging. There are many human body parts and potential findings that a doctor must examine and consider to provide a complete medical examination for each sickness or injury.

Many conditions of a human patient's body parts can be examined by an experienced doctor with a brief glance (e.g., the patent is sober and conscious, or the patient's right knee is not swollen). However, the information regarding these potential symptoms must be dictated by the treating doctor and must be properly transcribed by a medical transcriptionist to provide a patient medical record that complies with Medicare requirements. In this disclosure, the term “doctor” is intended to apply to any skilled medical practitioner who utilizes the medical treatment template. Similarly, the term “transcriptionist” is intended to apply to any individual, or speech recognition computer-based program, that generates medical records using the medical transcription system 300. It is often the sheer volume of conditions and symptoms that must be competently examined, as well as being certain of which conditions and symptoms to examine, that leads to errors, omissions, and over-treatment for medical examinations as well as inaccurate or incomplete filing in of medical records, forms, and letters.

Providing one embodiment of a medical report requires two aspects. One aspect includes a compilation of the doctor input that is typically stored as voice recorded on tape, and only requires a doctor to dictate those input values where the input values differ from some default value. An example of a default value might be that a particular knee is not swollen. The use of such default values is appropriate for medical treatment template 100 where the default value is common to most patients. Since, e.g., most patients visiting doctors for routine exams do not have swollen knees (or other such conditions or symptoms that must be examined), the doctor does not have to dictate the non-default values for many fields. This limiting the number of fields having negative findings that must be dictated represents a considerable time saving considering the large number of negative findings in most medical exams. The medical treatment template 100 requires that the doctor dictate only those fields having positive findings, as well as the patient-specific fields.

Physicians, being human, tend not to forget to input the positive findings that indicate an injury, since it is obvious for doctors to detect symptoms. However, the physicians may have more difficulty remembering to document the negative findings since the negative findings are simply a list of possible symptoms and injuries that can be examined by a doctor, and may not relate to any injury of the patient. The template can also be used as a checklist to ensure that the doctor perform all the procedures necessary to comply with Medicare requirements. The medical examination typically occurs in the doctor's office, at the site of the patient, or in the hospital. The doctor can also use the medical treatment template 100 while dictating into a tape recorder following the examination to ensure that nothing that is necessary for a Medicare complaint exam has been omitted by the doctor during the dictation relating to the examination.

Another aspect of providing a medical record relates to the transcriptionist inserting the non-default values into a computer-based medical transcription template of a medical transcription system 300. A medical transcriptionist may input data that satisfies the Medicare requirements into the fields using the medical transcription system 300 quickly and reliably. Because the transcribed patient record relies largely on default fields in the medical treatment template 100, the transcriptionist has to type only the non-default fields dictated by the doctor.

In the transcription step, the transcriptionist has to input values in a medical transcription template located on a computer-based medical transcription system 300. There is also time saved since the medical transcriptionist has to input only default values. The medical transcription system 300 only requires that the transcriptionist type the positive findings.

This disclosure describes the doctors utilization of the medical treatment template as well as the transcriptionist's use of the medical transcriptionist template.

I. Medical Treatment Template

Multiple levels of medical examination/treatment are approved within Medicare guidelines. These levels are indicated as level one through level five, with the higher levels indicating more serious injuries that require more thorough exams. Doctors are reimbursed for a particular exam based on the level of the exam. The examination patient reports are to be Medicare compliant before Medicare payments are issued. Level-one examinations involve quick examinations, relating to relatively minor injuries, or many follow-up examinations. Level-two examinations (also referred to as expanded) involve a more thorough examination/treatment than level-one exams. Level-three examinations (also referred to as detailed examinations) allow for more involved exams by the treating doctors to consider more serious conditions. Level-four examinations (also referred to as comprehensive examinations) relate to relatively serious medical situations. Level-five examinations (also referred to as comprehension-plus examinations) relate to even more serious conditions than level-four examinations.

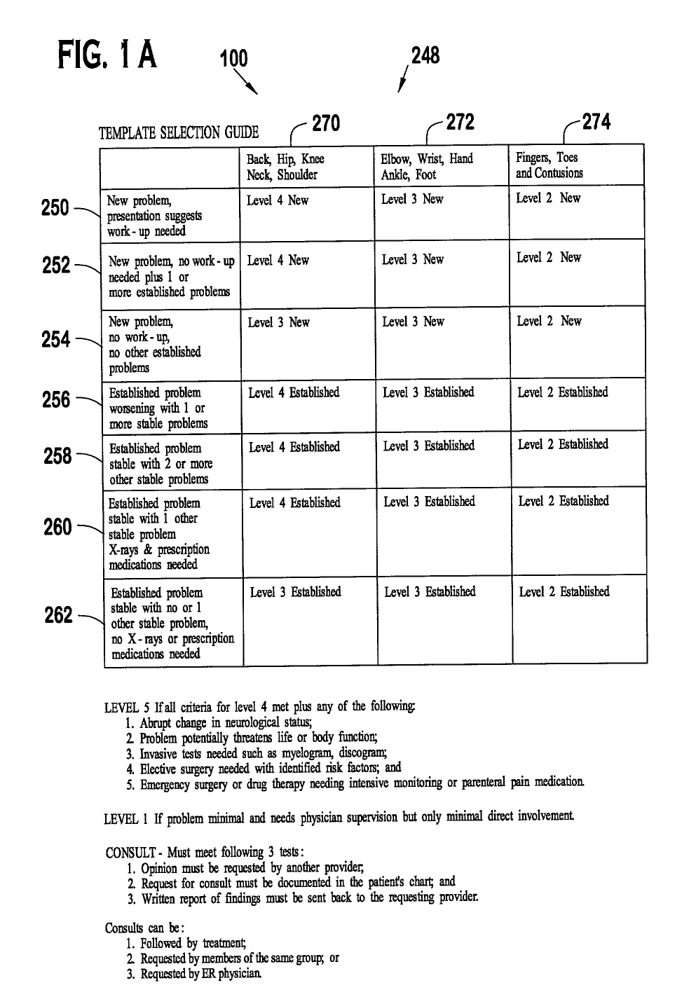

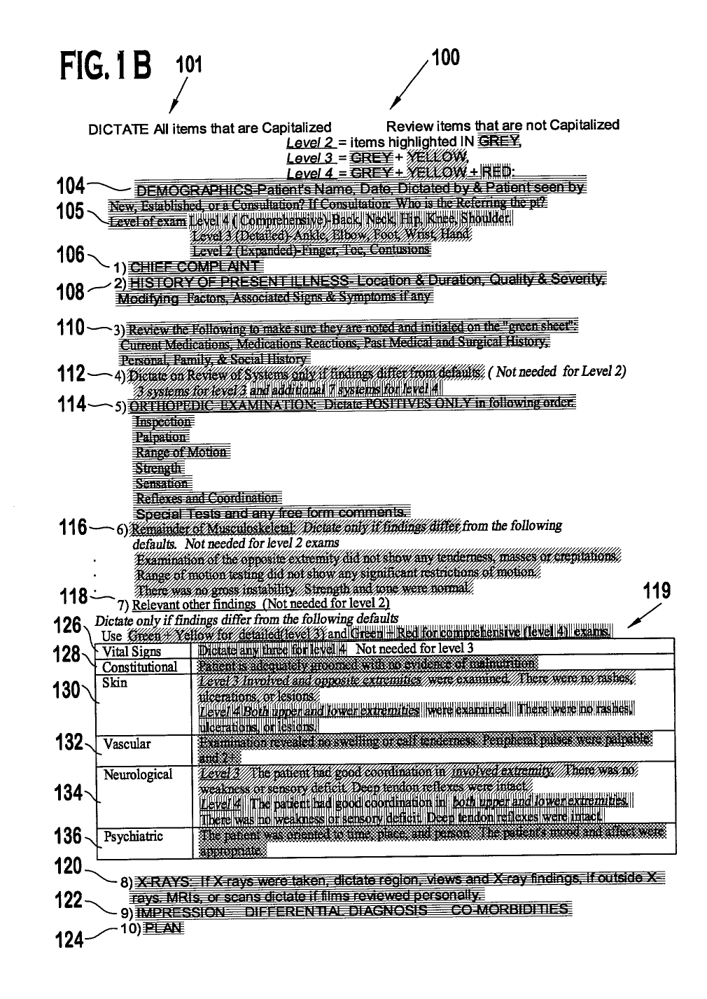

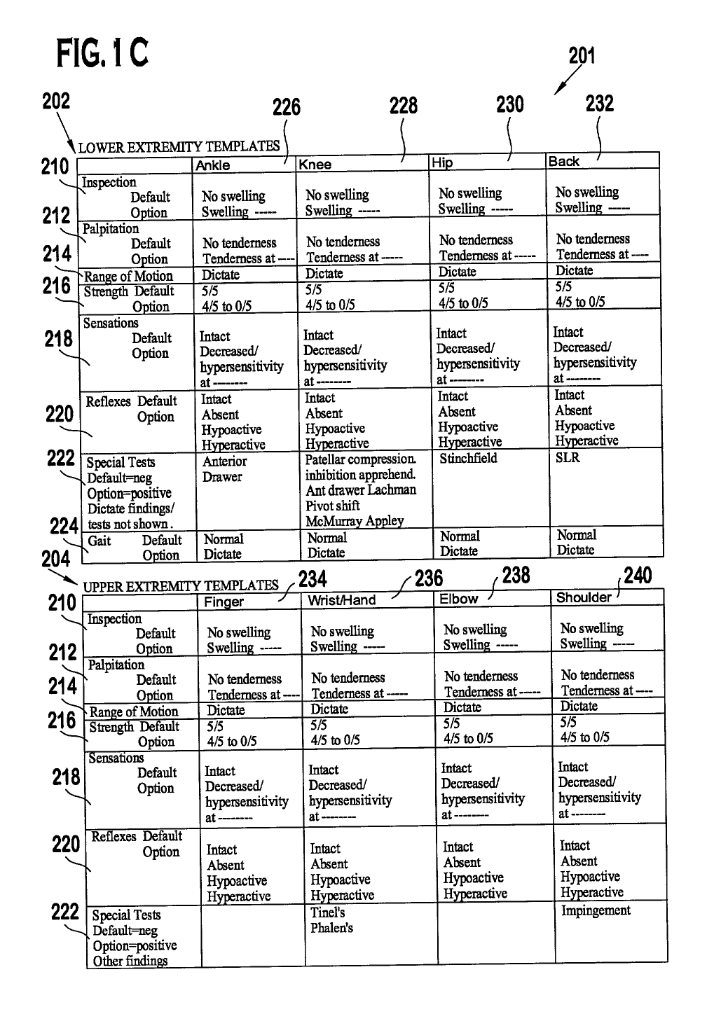

As the level of examination increases, so does the service level. For example, a level one exam may be performed by only support personnel without the direct involvement of a doctor. A level-two exam may require ten minutes of doctor time. A level-three exam may require fifteen minutes of doctor time. A level-four exam may require half an hour, or even more of doctor time. These four levels of exam are the levels characterized by the medical treatment template 100 of the present invention as shown in FIG. 1. The medical treatment template 100 and the medical transcription system 300 may relate to more or less than four levels, and the number of levels, as well as the characteristics of each level, is illustrative in nature and not limiting in scope.

Medicare thus dictates the service based on the allotted time that a doctor should devote to each specified level of treatment. When a doctor submits a claim, the doctor has to indicate which level of service is provided. Doctors have to document the level of service that complies with Medicare requirements. If a doctor is audited for the billing of a particular Medicare exam (after the doctor has billed for a certain level of exam), it is important for the doctor to properly document the exam by producing a Medicare-compliant patient record for that level of exam. All doctors (including general practitioners and specialists) have the capability of treating from Medicare level one to level five exams. The levels are based on the treatment that the doctor rendered. However, doctors often do not know what is necessary to document in order to comply with the Medicare levels. Many cryptic hand-written notes (that doctors had historically made, and sometimes still do make), to describe the examinations, treatments, and/or conditions do not comply with any Medicare level since they do not include the level of treatment and the associated examination.

The medical treatment template 100 to be used by doctors to assist in dictating patient records is described in this section. There are three portions of the medical treatment template shown, respectively, in the embodiment of medical treatment template 100 of FIGS. 1A, 1B, and 1C. FIGS. 1A, 1B, and 1C show, respectively, embodiments of a template selection guide portion 248, an exam level portion 101, and a default/option portion 201 that are each included in the medical treatment template 100.

Clinical information and billing information are two types of information that may be input in using the medical treatment template 100. For example, the doctor can dictate certain answers provided by the patient in the patient intake form or questionnaire (known as a green sheet that is generally known often used in the medical area) that is completed by the patient prior to the examination. Clinical information includes the information that the doctor obtains during the examination. When a patient arrives at a doctor's office for treatment, the doctor first examines the patient's chart including a patient intake questionnaire (the green sheet); the doctor then examines the patient. The doctor often bases his treatment on input from the green sheet, physical observations of the patient, answers by the patient of doctor's questions, examination using medical devices, and other considerations. For example, work-up needed, treatment provided, and the like are examples of clinical information. Whether a patient's shoulder hurts, what type of pain is felt (e.g., sharp or dull), and other such information is clinical information relating to the actual physical manifestation of the injury. All of this information relating to interaction between a doctor and a patient during an examination is clinical information. Clinical information also includes information related to patient history and the medical decision-making issues involved in patient care.

Billing information relates to the number assigned to each procedure for billing purposes. For example, each specific Information and Communication Technologies (ICT) number, such as e.g., 9239.6 relates to a specific injury such as shoulder pain, secondary tendentious. ICT is a system of disease classification that is used by insurance companies to record diagnosis in numeric format. The doctor can dictate using the medical treatment template that the examination is, e.g., a level-three examination which indicates the approximate doctor time that should be allotted to the exam. The billing information includes the level of the exam since the duration of the exam relates directly to the billing process.

The fields included in the medical treatment template 100 are designed to conform with the essential information needed for an insurance claim. For instance, the medical treatment template 100 includes fields for the site of service, the ICT numbers, and the current procedure terminology (CPT) code numbers. CPT is a standardized numerical coding scheme that has been devised by the AMA to code medical services that are performed including evaluation. These fields of the medical treatment template 100 relate to billing. ICT information, that include numbers and/or letters, describe a variety of specific injuries in a manner that complies with Medicare guidelines. The insurance forms indicate a specific ICT number that relates to a specific injury.

The examining doctor can dictate input modifiers to the appropriate field of the medical treatment template 100. Modifiers are used to describe special circumstances attached to a service (for example, if surgery is done on thumbs on both sides, to avoid confusion that this is a duplicate claim). Modifiers can be used, for example, to indicate that the surgery was on two separate areas at the same sitting. Typically, charges for the second site are reduced 50% under Medicare. For example, if the doctor examined a different number of extremities from the normal value for that level of examination, then the extremities field is modified. In this way, when a doctor bills for a certain level of exam, the documentation supports and complies with that level of exam.

As an example, in a level-four or level-five exam (for, e.g., an injured hip and leg), the doctor checks all four extremities. In a level-three exam (for, e.g., an injured leg), the doctor checks only the two lower extremities or the upper two extremities depending on the location of the injury. In a level-two exam (for, e.g., an injured finger), the doctor only checks the injured body part. The doctor cannot perform a higher level exam than dictated by the level of the injury and still comply with Medicare guidelines and be correctly reimbursed by Medicare. Likewise, the doctor cannot perform a lower level exam than dictated by the level of the injury and still provide adequate service to the patient, nor will such a deficient exam comply with Medicare requirements. For example, if a doctor sees a patient with a level-two injury (a finger injury is an example), there is no reason for the doctor to examine all four extremities as required for level-four and level-five exams (but not required for level-one, level-two, or level-three exams) since the doctor would not be able to justify billing for a level-four exam. The medical treatment template 100 allows the doctor to determine the maximum level of examination for which the doctor can charge while still complying with Medicare requirements.

Though only level-two, level-three, and level-four exams are actually referred to on the face of the embodiment of medical treatment template 100 shown in FIGS. 1A, 1B, and 1C, the medical treatment template 100 can be applied to all five levels of exams. Level-one exams, for example, typically do not require a doctor's involvement. Medical support personnel may perform the level one exam and complete the patient's records in a similar manner as the doctor would with a level-two exam. A level five exam involves a more serious injury than a level-four exam; however, the information that will be obtained at both levels of exam will be substantially the same. The fields of the medical treatment template 100 are thus identical for level-four and level-five exams.

One embodiment of medical treatment template 100 includes those portions shown in FIGS. 1A, 1B, and 1C. One embodiment of template selection guide 248 is shown in FIG. 1A. The template selection guide 248 indicates the Medicare level of examination that is required for certain injuries or illnesses. Based on the Medicare level selected by the doctor, the doctor will determine which level to apply to the exam-level portion 101 of the medical treatment template 100. The doctor will dictate particular fields in the exam-level portion 101 based on the particular level. Additionally, based on the particular level selected by the doctor, the medical transcriptionist will select a particular transcription template, and input the information into the applicable fields as indicated by the dictating doctor.

The doctor can determine the suitable level of treatment based on the appropriate Medicare level indicated by the template section guide 248 of the medical treatment template 100. The template section guide 248 is used by the treating doctor to determine the level of service applicable to a patient by applying objective rules to the patient's answers to the patient intake questionnaire (green sheet as referenced herein). The objective rules provided by the template selection guide 248 act to identify a level of service that maximizes the amount of reimbursement associated with an examination. A doctor having some experience with the medical treatment template 100 may be able to ascertain the level of a particular examination without referring to the template selection guide. The embodiment of template selection guide 248 as shown in FIG. 1A is configured as a table having rows 250, 252, 254, 256, 258, 260, and 262 indicating the symptoms. The columns 270, 272, and 274 of the template selection guide 248 represent the location of the injury or symptoms. For example, column 270 relates to back, hip, knee, neck and shoulder injuries or illnesses. Column 272 pertains to elbow, wrist, hand, ankle, and foot injuries or illnesses. Column 274 relates to injuries to or illnesses of fingers or toes, or contusions.

The rows 250, 252, 254, 256, 258, 260, and 262 of the template selection guide 248 represent the type of problem (new, old, stable, worsening, etc.). For example, row 250 relates to a new problem, presentation suggests work-up is needed. Using the template selection guide 248, if the row 250 situation applies to one of the column 270 body parts, then a level four new exam should be performed. If row 250 relates to one of the column 272 body parts, then a level three new exam should be performed. If the row 250 situation applies to a column 274 body part, then a level-two new exam should be performed.

The template selection guide 248 further includes in row 252 any new problem where no work-up is needed where there are one or more established problems. If the row 252 situation applies to a column 270 body part, then the level-four new exam should be performed. If the row 252 situation applies to a column 272 body part, then a level three new exam should be performed. If a row 252 situation applies to a column 274 body part, then a level-two new exam should be performed. The template selection guide 248 further includes in row 254 any new problem, no work-up, where there are no other established problems. If the row 254 situation applies to a column 270 body part, then a level-three new exam should be performed. If the row 254 situation applies to a column 272 body part, then a level-three new exam should be performed. If the row 254 situation applies to a column 274 body part, then a level-two new exam should be performed.

The template selection guide 248 further includes the row 256 for an established problem worsening with one or more other stable problems. If the row 256 situation applies to a column 270 body part, then a level-four established exam should be performed. If the row 256 situation applies to a column 272 body part, then a level-three established exam should be performed. If the row 256 situation applies to a column 274 body part, then a level-two established exam should be performed. The template selection guide 248 further includes an established problem stable with two or more other stable problems row 258. If the row 258 situation applies to a column 270 body part, then a level-four established exam should be performed. If the row 258 situation applies to a column 272 body part, then a level-three established exam should be performed. If the row 258 situation applies to a column 274 body part, then a level-two established exam should be performed.

The template selection guide 248 further includes an established problem stable with one other stable problem, X-rays and prescriptions needed 260. If the row 260 situation applies to a column 270 body part, then a level-four established exam should be performed. If the row 260 situation applies to a column 272 body part, then a level-three established exam should be performed. If the row 260 situation applies to a column 274 body part, then a level-two established exam should be performed. The template selection guide 248 further includes an established problem stable with no one or other stable problem, no X-rays or prescriptions needed row 262. If the row 262 situation applies to a column 270 body part, then a level three established exam should be performed. If the row 262 situation applies to a column 272 body part, then a level-three established exam should be performed. If the row 262 situation applies to a column 274 body part, then a level-two established exam should be performed.

As indicated in the text below the template selection guide 248, level five exams should be performed if all the criteria for a level-four exam are met plus any of the following: (a) there is an abrupt change in neurological status; (b) the problem potentially threatens life or body function; (c) invasive tests are needed such as a myelogram or discogram; (d) elective surgery is needed with identified risk factors; or (e) the problem calls for emergency surgery or drug therapy needing intensive monitoring or parenteral pain medications. A level-one exam should be performed if the problem is minimal and needs physician supervision, but only minimal direct involvement.

As indicated in the text below, in the embodiment of template selection guide 242 shown in FIG. 1A a consultation must meet the following three tests: a) the opinion must be documented by another provider, b) the request for consult must be requested in the patient's chart, and c) the written report of findings must be resubmitted to the requesting provider. A consultation that satisfies these three requirements can be followed by a treatment, requested by members of the same group, or requested by emergency room physicians.

An embodiment of the exam-level portion 101 of the medical treatment template 100 is shown in FIG. 1B. The exam level portion 101 is used by the doctor to provide an examination corresponding to the level of service derived by the template selection guide 248. The doctor interface with the template selection guide 248 is partially based on the patients answers provided by the patient intake questionnaire (the green sheet). While one embodiment (not shown) of the exam-level portion 101 is color coded, another embodiment of the exam-level portion 101 is shown in FIG. 1B with shading including, e.g., vertical lines, angled lines, or horizontal lines. Color coding is more likely to be used in most actual embodiments of exam level portions 101, than shading or hatching due to an improved detectability of different colors. However, for the purpose of the figures in the present application, the shading lines are used. The exam level portion 101 of the medical treatment template 100 may be color-coded with horizontal hatching lines or in a prescribed color such as grey (for those portions of the template that apply to level two and above), with angled hatching lines or in yellow (for those portions of the template that apply to level three and above), with horizontal shading lines or in red (for those portions of the template that apply to level four and above), and with criss-crossed angled shading or in green. The criss-cross shading relates to general considerations such as appearance, vascular, psychiatric, etc. The areas of portion 101 corresponding to level-two and above, level-three and above, and level-four and above exams may be color-coded or criss-hatched. In portion 101, for example, all text that is highlighted in horizontal lines, or in color coding (grey) applies to level-two and above exams. As such, all information highlighted in grey will be obtained during level-two, level-three, level-four, and level-five exams.

For level-three exams using the exam-level portion 101 of the medical treatment template 100, the doctor will provide all the information called for in the horizontal hatched (grey) as well as the angled hatching (yellow) highlighted areas. As such, doctors providing a Medicare-compliant level-three exam will provide information for all fields hatched in horizontal or angled hatching of the exam-level portion 101 of the medical treatment template 100. In performing a level-four or level-five exams, the doctor will obtain all the information highlighted in the horizontal, angled, and vertical hatched areas of the exam-level portion 101 of the medical treatment template 100. As such, doctors providing a Medicare-compliant level-four exam will produce information for all matters that are highlighted in horizontal, angled, and vertical hatched portions of the exam-level portion 101 of the medical treatment template 100.

There are a variety of portions included in the embodiment of the exam-level portion 101 of the medical treatment template 100 shown in FIG. 1B. These portions include a demographics portion 104, a level of exam portion 105, a chief complaint portion 106, a history of present illness portion 108, a review the following portion 110, a dictate portion 112, an orthopedic examination portion 114, a remainder of muscloskeletal portion 116, a relevant other findings portion 118 including a default/option table 119 showing multiple-sub-fields described herein, an X-rays portion 120, an impression, differential diagnosis, co-morbidities portion 122, and a plan portion 124.

One embodiment of the demographics portion 104 includes a patient's name field, a date field, a dictated by field, a patient seen by note, and a new, established or consultation field, which includes a referring physician field. If the doctor is brought in for a consultation, in the demographics portion 104 the doctor dictates the name of referring doctor for the referring physician field. One embodiment of the level of exam portion 105 includes a description of the portions of the body that fall within certain exam levels. For example, the level-four (comprehensive) exam relates to the back, the neck, the hip, the knee, and the shoulder. The level-three (detailed) exam relates to the ankle, the elbow, the foot, the wrist, and the hand. The level-two (expanded) exam relates to the finger, the toe, and contusions. The demographics portion 104 is highlighted in horizontal hatching (or is colored grey), and is therefore performed for all exams of level two and above.

One embodiment of the chief complaint portion 106 includes the chief complaints of the patient. There is no default value for the chief complaint portion 106 because the possible complaints are so numerous, variable, and inconsistent. In general, default values are provided in fields where many patients have the same value for that field. The chief complaint portion 106 includes information relating to the reasons for the patient's visit to the doctor. If the patient is visiting the doctor for a routine check-up, the doctor can dictate “routine check-up” for entry in the chief complaint portion 106. The chief complaint portion 106 is highlighted in horizontal hatching (colored grey), and is therefore performed for all exams of level two and above.

One embodiment of the history of present illness portion 108 includes information relating to the location, duration, quality, severity, modifying factors, and associated signs and symptoms of the present illness. This information is often received from the patient, but may include inserts from prior medical records, etc. With respect to the history of the illness, the medical treatment template 100 indicates five things about the present illness or injury: a) where it is located; b) how long the patient has had it; c) what kind of illness or injury it is; d) what aggravates it; and e) what makes it better. A consideration of all five of these things is required for a level-four exam. For example, a doctor may include a statement such as that the pain is located arterially, it has been tender for six months, is made worse by putting on clothes, and it is relieved by a massage. This statement complies with the requirements for a level-four exam. Without any template, doctors find it difficult to provide as succinct of a statement relating to the important aspects of an exam. The history of present illness portion 108 also includes modifying factors and associated signs and symptoms. The history of present illness portion 108 is highlighted in horizontal hatching (colored grey), and is therefore performed for all exams of level two and above.

The review portion 110 instructs the examining doctor to review the current medications, medications reactions, past medical and surgical history, and personal, family, and social history as indicated on prior medical records that are typically maintained in hard-copy or data form in doctors' offices. The different portions of the green sheet (the initial patient questionnaire that the patient completes prior to the exam) are referenced in the review portion 110. Green sheets are typical patient information intake sheets. Certain normal values of the green sheet may be included as default values in the review portion 110. The review portion 110 is highlighted in horizontal hatching, and as such is to be performed for all exams of level two and above.

The dictate portion 112 instructs the examining doctor to dictate on review of systems only if the findings differ from default values. The dictate portion 112 relates to the review portion 110. A segment of the dictate portion 112 is highlighted by angled hatching indicating that a level-three exam is to be performed if the three highlighted systems are found. System review questions are answered by looking at the green sheets (medical patient intake forms) only if the findings differ from the default values. The green sheet queries the patient about personal medical history, purpose of exam visit, and other related information. The patient completes the green sheet by filling in answers to the green sheet “questionnaire.” Another segment of the dictate portion 110 is highlighted in red indicating that a level-four exam is to be performed if an additional seven systems are located.

The orthopedic examination portion 114 instructs the examining doctor to dictate only positives (where the answers differ from the default values) in the following order: inspection, palpation, range of motion, strength, sensation, reflexes and coordination, and special tests. The doctor can review the embodiment of the default/option values for the orthopedic examination portion 114 in the lower extremity template 202 and the upper extremity template 204 of the default/option portion 201 as shown in the embodiment of the default/option portion 201 in FIG. 1B. The orthopedic examination portion 114 is highlighted in horizontal hatching, and as such is to be performed for all exams of level two and above.

The muscloskeletal portion 116 instructs the examining doctor to dictate only if the findings differ from any of the following three default conditions (a) the examination of the opposite extremity did not show any tenderness, masses, or crepitations; (b) the range of motion testing did not show any significant restrictions of motion; or (c) there was no gross instability (strength and tone were normal). The muscloskeletal portion 116 is highlighted in angled hatching (or yellow color), and is therefore performed for all exams of level three and above.

The relevant other findings portion 118 includes the default option table 119 and instructs the examining doctor to dictate only if the findings differ from the defaults shown in the default/option table 119. The default/option table 119 includes as sub-fields a vital signs sub-field 126, a constitutional sub-field 128, a skin sub-field 130, a vascular sub-field 132, a neurological sub-field 134, and a psychiatric sub-field 136.

The vital signs sub-field 126 instructs the doctor to dictate any three vital signs for a level-four exam. The vital signs sub-field 126 is highlighted in vertical hatching, indicating that this sub-field is for level-four exams. The default value of the constitutional sub-field 128 indicates that the patient is adequately groomed with no evidence of malnutrition. If this default value is incorrect, based largely on visual clues, the doctor is to dictate the correct information for the constitutional sub-field 128. The constitutional sub-field 128 is highlighted in cross-hatching (or is colored green), and is performed for all exams.

The skin sub-field 130 includes a level-three segment and a level-four segment. The level-three segment, which is highlighted in angled hatching, indicates as a default that the involved and opposite extremities were examined and there were no rashes, ulcertations, or lesions. The doctor is to dictate the correct information for a level-three exam and higher if this statement is incorrect. The level-four segment, which is highlighted in vertical hatching, states as a default that the upper and lower extremities were examined and there were no rashes, ulcerations, or lesions. The doctor is to dictate the correct information for a level-four exam and higher if this statement is incorrect.

The vascular sub-field 132 indicates, as a default that is to be examined for all levels common that the examination revealed no swelling or calf tenderness, and peripheral pulses were palpable and 2+. If this default value is incorrect, the examining doctor is to dictate the correct statement. The vascular sub-field 132 is highlighted in cross-hatching (or is colored green), and is performed for all exams. The neurological sub-field 134 includes a level-three and above segment (highlighted in angled hatching) and a level-four and above segment (highlighted in vertical hatching). The level-three and above segment indicates as a default that: a) the patient had good coordination in the involved extremity; b) there was no weakness or sensory deficit, and c) deep tendon reflexes were intact. If the statement in the default field is inaccurate, the examining doctor is to dictate the correct statement for a level-three exam. The level-four segment indicates as a default that: a) the patient had good coordination in upper and lower extremities; b) there was no weakness or sensory deficit; and c) deep tendon reflexes were intact. If the statement in this default field is inaccurate, the examining doctor is to dictate the correct statement for a level-four exam.

The psychiatric sub-field 136, highlighted in cross-hatching and to be considered for all levels, indicates as a default that the patient was oriented to time, place, and person, and that the patient's mood and affect were appropriate. If this default statement is inaccurate, the examining doctor is to dictate the correct statement.

The X-rays portion 120 (highlighted in horizontal hatching) indicates if X-rays were taken, then the doctor is to dictate region, views, and X-ray findings. The X-rays portion also indicates whether outside X-rays, Magnetic Resonance Images (MRI), or scans were done. The doctor is to dictate if the films were reviewed personally. The examining physician therefore dictates the particulars about the X-rays taken for all exams of level two and above. The impression, differential diagnosis, co-morbidities portion 122 allows the treating doctor to dictate any matter relating to these three considerations in all exams of level two and above. The plan portion 124 allows the examining doctor to dictate the treatment plan for all exams of level two and above.

The seriousness, and location, of an injury are considered in determining the amount of time that a doctor may spend on a Medicare-compliant exam. For instance, a level-four (comprehensive) exam involves the back, neck, hip, knee, or shoulder. A level three (detailed) exam involves the ankle, elbow, foot, wrist, or hand. A level-two (expanded) exam involves a finger, a toe, or a contusion.

Based on the level of exam indicated in the demographics portion 104, a doctor is referred to the default/option portion 201 of the medical treatment template 100, one embodiment of which is shown in FIG. 1C. The lower extremity template 202 and the upper extremity template 204 of the default/option portion 201 are configured nearly identically, but pertain to different parts of the body. The extremity templates 202 and 204 of the default/option portion 201 provide the default condition and any option condition for each of the various fields. The fields in the extremity templates 202, 204 of the default/option portion 201 include the inspection field 210, palpation field 212, the range of motion field 214, the strength field 216, the sensations field 218, the reflexes field 220, the special tests field 222, and (in the case of the lower extremity segment) the gait field 224.

The various columns in the lower extremity template 202 and the upper extremity template 204 include the various parts of the body. For example, the columns in the lower extremity template 202 include the ankle column 226, the knee column 228, the hip column 230, and the back/neck column 232. The upper extremity template 204 includes the finger column 234, the wrist/hand column 236, the elbow column 238, and the shoulder column 240. The level of exam for each of these columns depends upon the particular body part. For example, the ankle column 226 has been described in the demographics portion 104 of the medical treatment template 100 in FIG. 1A as being a level-three (detailed) exam. The hip column 230 relates to level-four comprehensive exams.

Considering the ankle column 226, as an example of the fields included in a column, a doctor using the default/option portion 201 will initially come to the inspection field 210. The default value for the inspection field 210 is no swelling. The option value for the inspection field 210 is swelling to some degree. If the doctor noticed some swelling during the examination, the doctor will dictate information about the swelling. By comparison, if the patient has no swelling, the doctor does not have to dictate that no swelling exists since this is a default (negative) value that is automatically input by the use of the medical treatment template. Similarly, the default value for palpation is no tenderness. The option value is tenderness at some described location. Therefore, if the doctor noticed some tenderness, the doctor will dictate the location of the tenderness to modify the default value to some non-default value.

The range of motion field 214 has no default value and thus requires dictation by the doctor, since there will be a wide variety of ranges of motion for each patient. Continuing to the strength field 216, the default option for the ankle column 226 used is 5 of 5, with other body parts. The option value, to be dictated by the doctor, would range from 4 of 5 to 0 of 5. In the sensations field 218, the default option is intact indicating that the patient experienced normal sensations in the ankle. The option value for the sensations field 218 is some decreased sensation or hypersensitivity at certain locations. The reflexes field 220 describes the reflexes of the patient. The default option is intact, which describes normal reflexes. The option values include intact, hypoactive, or hyperactive reflexes.

The special tests field 222 for the ankle column 226 lists the various tests that were performed for each body part. The default value is negative, indicating that tests were not performed. The option value is positive, indicating that tests were performed. In the ankle column 226, the physician will indicate the anterior test or the date test. The physician is also prompted to dictate tests. In the gait field 224, the default option is for normal gait 224. The option is for an abnormal gait, in which case, the doctor should dictate the abnormality of the gait.

Each column, including the ankle column 226, the knee column 228, the hip column 230, the back/neck column 232, the finger column 234, the wrist/hand column 236, the elbow column 238, and the shoulder column 240, contains similarly directed default and option values, as those described for the ankle column 226 in fields 210, 212, 214, 216, 218, 220, 222, and 224. The list of columns in the default/option portion 201 as well as the exam-level portion 101 of the medical treatment template 100 is meant to be illustrative and not limiting in scope. In other words, the doctor can apply the concepts illustrated in the embodiment of medical treatment template 100 shown in FIGS. 1A, 1B, and 1C to other body parts, different types of doctors, different types of treatments, and exams, etc. without departing from the intended scope of the present invention.

Perhaps the doctor still wants to perform a more complete exam than the level that is compliant with Medicare based on the injury. Since the higher level exam would not comply with Medicare requirements, the doctor would likely have to absorb the cost of the higher level exam or bill the patient directly. The medical treatment template 100 provides the doctor an indication of the level of treatment that can be provided while remaining Medicare compliant. The medical treatment template also indicates to the doctor the type of input that is necessary in exams for certain levels of injury and illness. Use of the medical treatment template 100 limits doctors' precious time spent on complying with Medicare guidelines and assists the doctors in quickly and effectively dictating in a manner that is used to generate patients records that comply with Medicare guidelines. The medical treatment template thus appropriately directs the examination based on the location and type of injury.

If a patient goes into a doctor's office indicating that he or she has a complex medical problem, a higher level exam will be allowed by Medicare than for a simple medical problem. For example, a patient with seizures and needing amputations represent a complicated issue that justifies a level-four or level-five examination. Treatment or examination of such a complex medical situation necessitates the additional medical time to treat. The exam for the complex patient should thus be documented to a level four or a level five exam, as appropriate. The level-four examination requires that the doctor check all four extremities as indicated in portions 130 and 134 of FIG. 1B. Doctors following the medical treatment template 100, in concurrence with their medical experience and training, will realize that they have to check all four extremities of the patient. In a level-four exam, there are 63 bullet items listed on the medical treatment template 100 that have to be performed. For example, the doctor has to look at (and document in the patient medical record) the mental state of the patient. The medical treatment template 100 allows the doctor to efficiently perform this documentation.

The medical treatment template 100 matches and documents the level of service provided to what is a medically reasonable level of reimbursement. In other words, the medical treatment template limits the probability that examining doctors will overbill the government or insurance companies. The government medical service providers such as Medicaid and Medicare (and insurance companies) assume that doctors should be paid fairly for their services, but also that doctors should not be overbilling or underbilling. The medical treatment template 100, used in combination with the medical transcription system 300, limits the probability of overbilling and underbilling.

Often one of the reasons doctors overbill or underbill is because the doctors don't understand, or don't have time to fully read, the voluminous Medicare requirements. One of the reasons why the doctors underbill is that they are not sure if they performed all the treatments necessary per Medicare guidelines. The doctors don't remember what treatment is necessary. The medical treatment template 100 provides the bullet points for each Medicare-compliant level. It is very hard for doctors to remember each one of the numerous aspects of examination for a particular injury. That is, a level four exam for example, includes 63 bullet points that must be complied with to satisfy the medical exam. Therefore, the medical treatment template 100 requires that the doctor look at the mental status, seven vital signs, the gait, the skin at all four extremities, the range of motion, the coordination, the reflexes, the vascular, other extremities, and a number of other potential symptoms. Sometimes during exams doctors don't remember each of these potential symptoms.

The medical treatment template 100 acts as a check-list to ensure that the doctor checks each item that should be checked for a particular level of exam. The medical treatment template 100 for a medical doctor may be analogized to a check list in aviation for a pilot. However, aviation check lists apply to pilots checking the state of a single type of aircraft which that pilot typically operates. Doctors have to treat a variety of injuries to a variety of body parts. Doctors can utilize a checklist, as provided by the medical treatment template 100, for a variety of body parts and a variety of levels of treatment that vary frequently. Orthopedic doctors, for example, treat such a wide variety of injuries, the treatment for each injury for a specified body part at a specified level is difficult for doctors to remember. That is one reason why the system provides different information for back, hip, and knee exams.

The difference between a level four exam and a level-five exam is not only what the doctor does in examination, but also what the doctor does in decision-making. If the doctor encounters something during a level-four exam that indicates a certain amount of bodily harm, the doctor can perform a level five exam. For example, if a patient suddenly can't move his or her leg, the doctor is justified in performing a level-five exam. The doctor has to document to the level four requirements anyway since the documentation for a level four exam and a level five exam is identical.

When a doctor performs a level-one exam, the doctor almost never will charge as a specialist during the examination since such routine examinations do not require the skill of a specialist. A generalist level one exam is, for example, a follow-up visit by a patient who had an ear infection treated, a hangnail removed, or some similar routine procedure performed. Another example of a level-one exam is receiving an injection for some treatment, or a follow-up visit after a patient received a negative tuberculosis (TB) test. Another level-one exam would be a follow-up for a patient who has recovered from an ear infection. In level-one exams, a doctor has previously treated the main injury, and the patient has recovered and is on a return visit. It is rare for a doctor to participate in a level-one exam; typically medical staff and assistants perform level one exams. The doctor, at most, supervises level one exams.

A doctor will use the medical treatment template 100 to determine the level of service appropriate for the degree of injury and the findings. The doctor has to check all the symptoms for all necessary extremities. The computer 280 provides a default indicating that the skin is normal (unless, of course, the doctor changes the value indicating that the skin is not normal). Allowing a computer to complete the default fields (instead of the doctor) limits the time necessary to complete a report for an examination. In other words, if the transcriptionist has to transcribe the normal values for each default field, the form would take considerable time to complete. Even dictating all the default values for a normal field would take considerable time considering that a typical completed form is approximately four to ten pages. Limiting the necessity for the doctor to dictate negative (default) findings is how the medical treatment template 100 may save doctors time by limiting the necessary dictation to non-default values. One way to limit the time necessary for a doctor to complete dictation associated with the medical treatment template 100 is to provide normal (typical) values for the default fields that the doctor does not have to dictate.

The default/option portion 201 of the medical treatment template 100 as shown in FIG. 1B shows the default fields. The defaults are built in the computer program of the medical transcription system 300. Assume a doctor is examining an ankle, the default value is that there is no swelling. If the doctor observes any variation from the default value (for example a swelling exists), the doctor dictates any deviations from the default values from the standard medical treatment template 100 form using the medical transcription system.

After the doctor has completed his dictation, the doctor has documented the services that have been provided and clinical information. The findings thus provide an indication of the necessary services to be provided that remain within Medicare guidelines. In other words, the medical treatment template 100 provides a technique to uniformly document examination of patients in a manner that remains within Medicare guidelines. The medical treatment template 100 allows doctors to dictate only positive findings, allowing the default (i.e. negative) findings to be inserted for the remainder of the medical treatment template 100.

It is to be understood that there are a variety of embodiments of medical treatment templates 100 that are intended to be within the scope of the present disclosure. The text can be modified in the part of the body examined, the type of examination, and/or the resultant text can be modified accordingly. For instance, the exam level portion 101 can be modified wherein instead of having different shadings relating to the different level of exams, different colors can be applied to highlight the text performed during different levels of exam. Alternatively, the text itself can be colored differently depending upon the level of exam to which that text relates. The different shadings, coloring, or highlighting in the exam level portion 101 of the medical treatment template 100 therefore indicate to the dictating doctor which text relates to certain prescribed levels of examination.

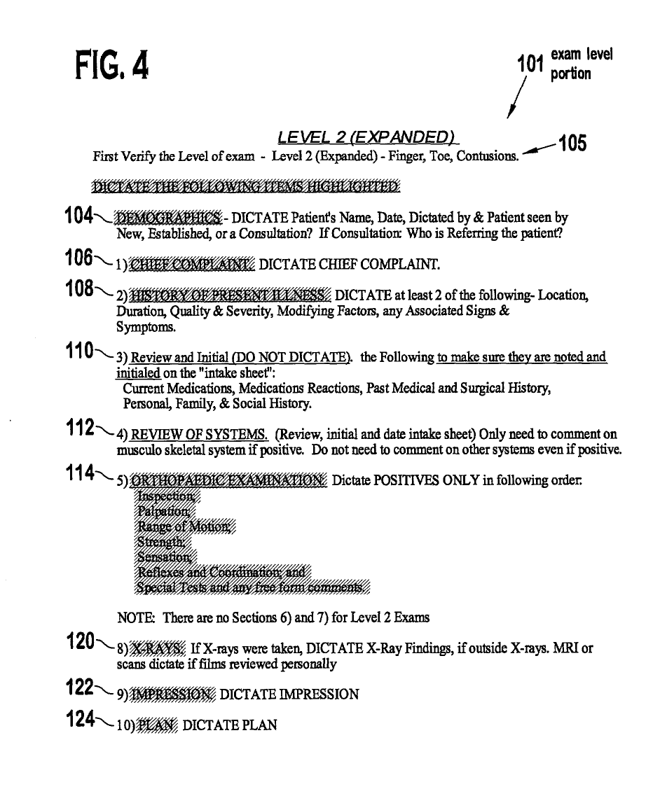

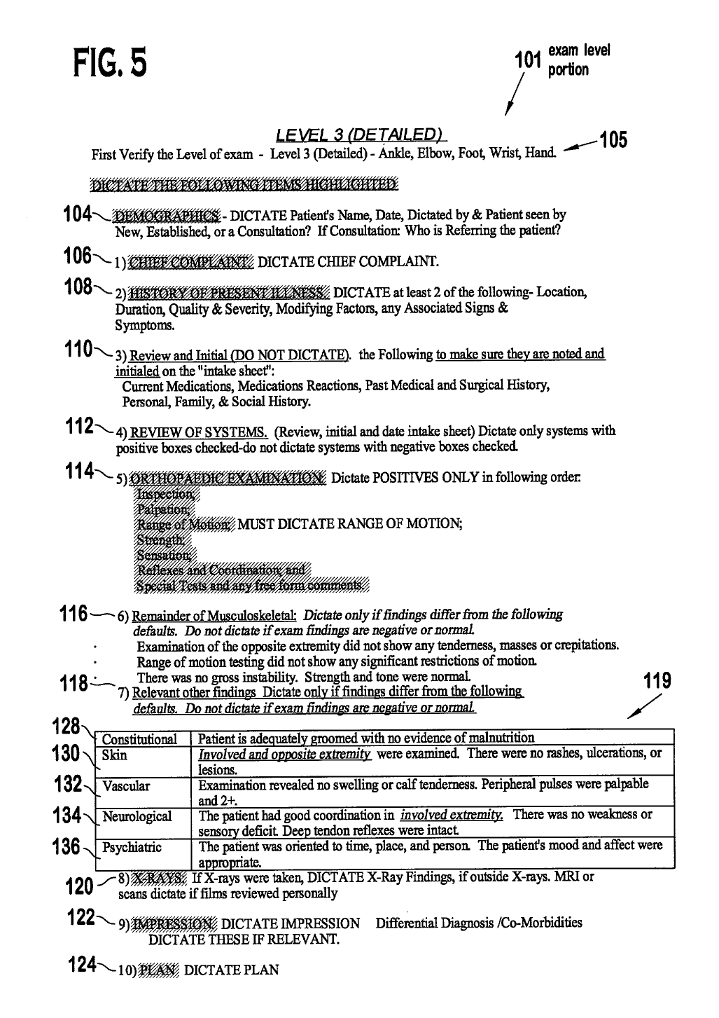

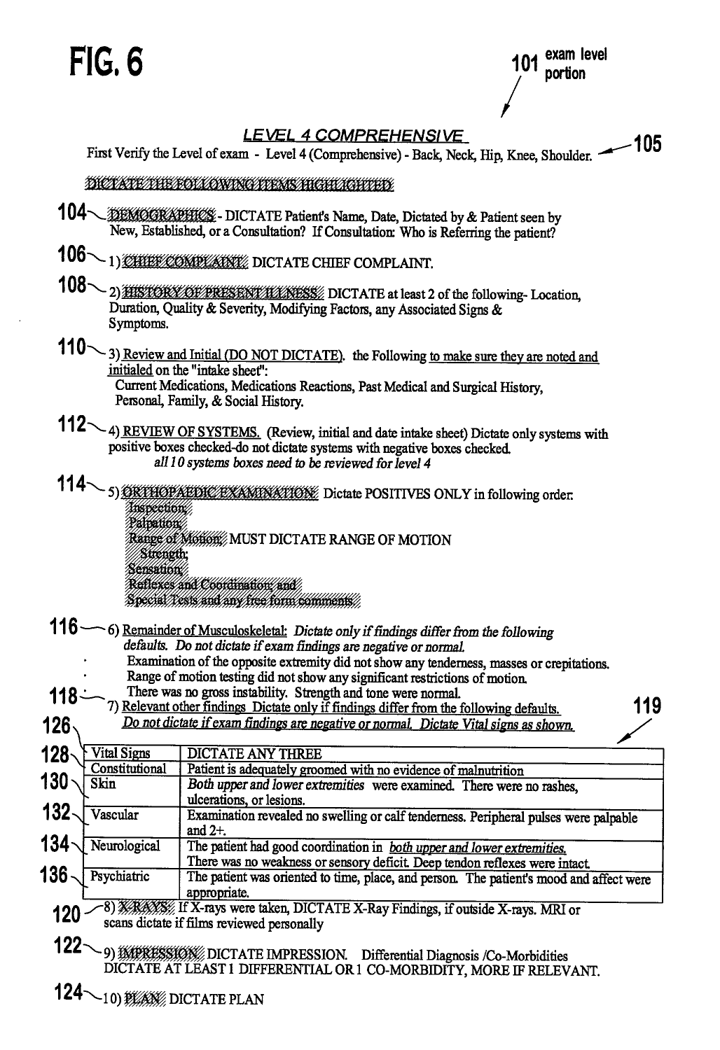

In alternate embodiments of exam level portion 101 as shown in FIGS. 4, 5, and 6, all the text for each particular level of examination can be segmented into distinct figures based on the level of exam. For instance, FIG. 4 shows one embodiment of an exam level portion 101 that relates to a level 2 (expanded) exam. FIG. 5 shows another embodiment of an exam level portion 101 that relates exclusively to a level 3 (detailed) exam. FIG. 6 shown yet another embodiment of an exam level portion 101 that relates to a level 4 (comprehensive) exam.

Comparing the exam level portion 101 in FIG. 4 with that shown in FIG. 1B, a considerable amount of similar text is included in both embodiments. For example, the FIG. 4 embodiment of exam level portion 101 (as well as the embodiments in FIGS. 5 and 6) includes the demographics portion 104, the chief complaint portion 106, the history of present illness portion 108, the view the following portion 110, the dictate portion 112, the orthopedic examination portion 114, the x-rays portion 120, the impression portion 122, and the plan portion 124, all of which were included in the embodiment shown in FIG. 1B. Missing from the FIG. 4 embodiment of exam level portion 101 is the remainder of muscloskeletal portion 116, the relevant other findings portion 118, and the entirety of the default/option table 119. These omitted portions in FIG. 4 are not required for level 2 (expanded) exams, and as such are not included. Additionally, all angled-hatched portions (corresponding to yellow), and all vertical-hatched portions (corresponding to red) are omitted in the embodiment of exam level portion 101 shown in FIG. 4, since they relate respectively to level 3 and level 4 exams exclusively and FIG. 4 relates to a level 2 exam. For instance, in the demographics portion 104, the level of exam is limited to the finger, toe, or contusion since this is level 2 exam. The text in the level of exam portion 105 that relates to level 3 and 4 exams is therefore omitted from the level 2 embodiment of exam level portion 101 shown in FIG. 4.

FIG. 5 shows another embodiment of exam level portion 101 of the medical treatment template 100. This embodiment of exam level portion 101 is directed to a level 3 examination, for instance, may be applied to an examination of a patient ankle, elbow, foot, wrist, and/or hand. The exam level portion 101 in FIG. 5 is directed to a level 3 exam in a similar manner as the embodiment shown in FIG. 4 is directed to a level 2 exam. However, additional portions are included in the exam level portion 101 of FIG. 5 because a level 3 exam is a more rigorous exam than a level 2 exam. For instance, the level 3 exam level portion 101 further includes the remainder of muscloskeletal portion, the relevant other findings portion 118, and the default/option table 119. The default/option table 119 includes the constitutional sub-field, the skin sub-field 130, the vascular sub-field 132, the neurological sub-field 134, and a psychiatric sub-field 136. Other portions of the exam level portion in FIG. 5 are modified to make it comply with a level 3 exam.

Similarly, FIG. 6 shows one embodiment of an exam level portion 101 that relates to a level 4 (comprehensive) exam. The exam level portion 101 is therefore directed, in this example, to back, neck, hip, knee, and/or shoulder examination, as indicated by the level of exam portion 105. The orthopedic examination portion 114 is identical in the embodiments of exam level portion shown in FIGS. 4, 5, and 6. The remainder of the muscloskeletal portion 116 is similar to that shown in FIG. 5, but is missing in the exam level portion of FIG. 4. The relevant other findings portion 118 is similar to as shown in FIG. 5, but is missing in FIG. 4. The default/option table 119 in the embodiment of exam level portion in FIG. 6 additionally has the vital signs sub-portion 126 in addition to the other sub-portion shown in the embodiment in FIG. 5. However, certain of the sub-portions in a level 4 (comprehensive) exam level portion 101 shown in FIG. 6 are modified, for example, to indicate that both upper and lower extremities are examined in a level 4 exam, wherein only the involved and opposed extremity are examined in a level 3 exam.

Upon consideration of the embodiments of exam level portions 101 of the medical treatment template 100 shown in FIGS. 1B, 4, 5, and 6, for each distinct level of exam, the exam level portions 101 contain virtually identical information. Multiple levels of exam may be integrated on the same template as shown in the embodiment in FIG. 1B, or alternatively, each level of exam may be provided with its own distinct exam level portion template 101. Various portions of the text may be highlighted in different ways using shading, hatching, coloring, or other techniques. However, each embodiment of exam level portion 101 (as shown in FIGS. 1B, 4, 5, and 6) of the medical treatment template 100 is configured to minimize the time necessary for a doctor to effectively dictate a Medicare compliant examination report, and additionally to limit the errors, omissions, and extraneous matters associated with such reports. Additionally, the medical treatment template 100, in all its different versions, may be used as an effective checklist by a doctor to ensure that the doctor has not omitted certain required portions of different levels of examination, or alternatively, that the doctor has not needlessly performed unnecessary, expensive, or potentially harmful procedures they are not required for certain levels of exam. The different embodiments of medical treatment template 100 are intended to be illustrative in nature and not limiting in scope. Similar medical treatment templates applied, e.g., to different treatments, levels of treatments, injuries, etc. are within the intended scope of the present invention.

II. Medical Transcription System

There are multiple aspects described in this disclosure, many of which act to save time for doctors, medical transcriptionists, report keepers, and other people. The described medical treatment template 100, including the template selection guide portion 248, an exam level portion 101, and a default/option portion 201 shown respectively in FIGS. 1A, 1B, and 1C, save doctor time by guiding doctors to effectively dictate in a manner to produce Medicare compliant patient records.

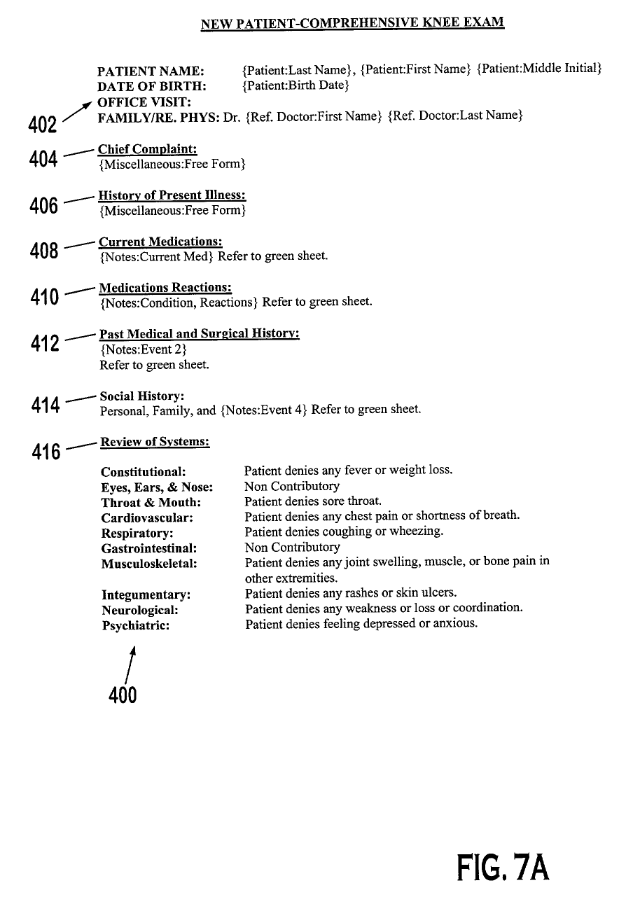

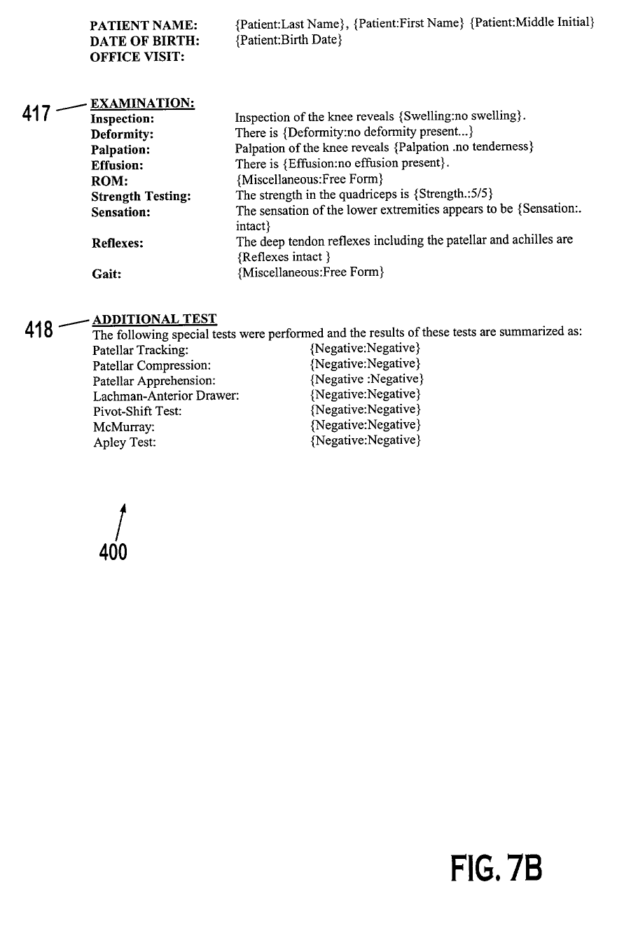

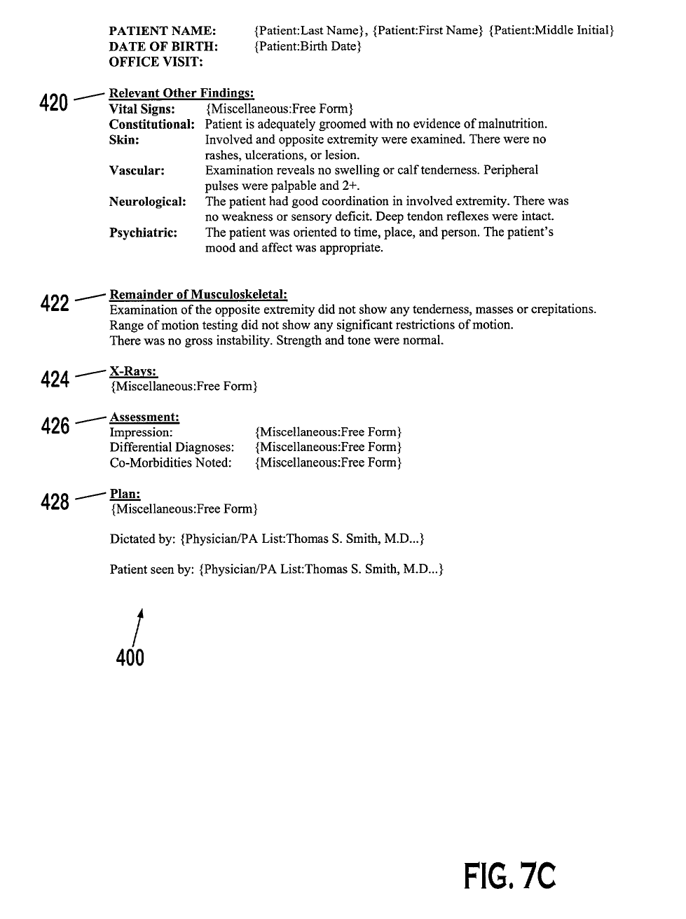

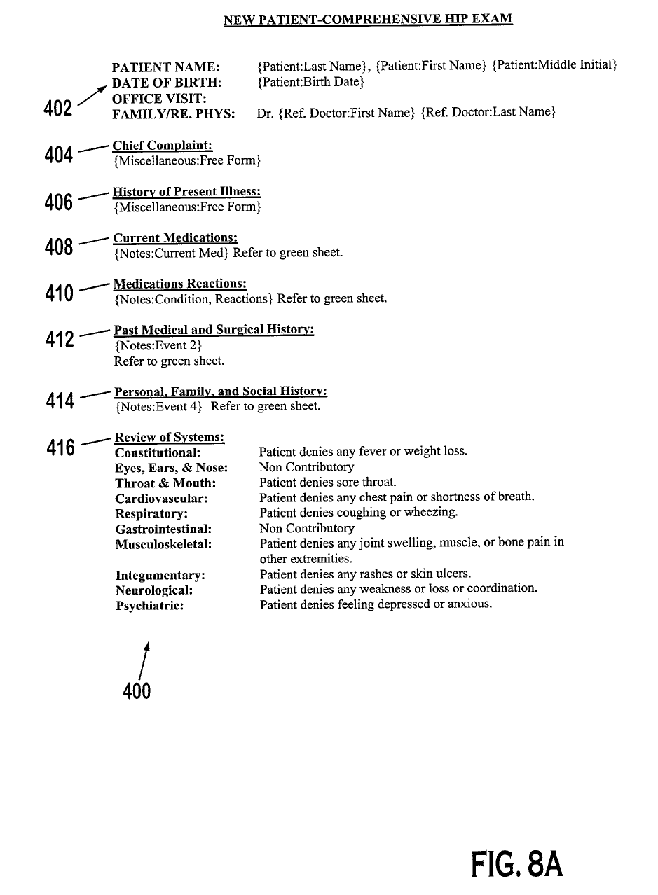

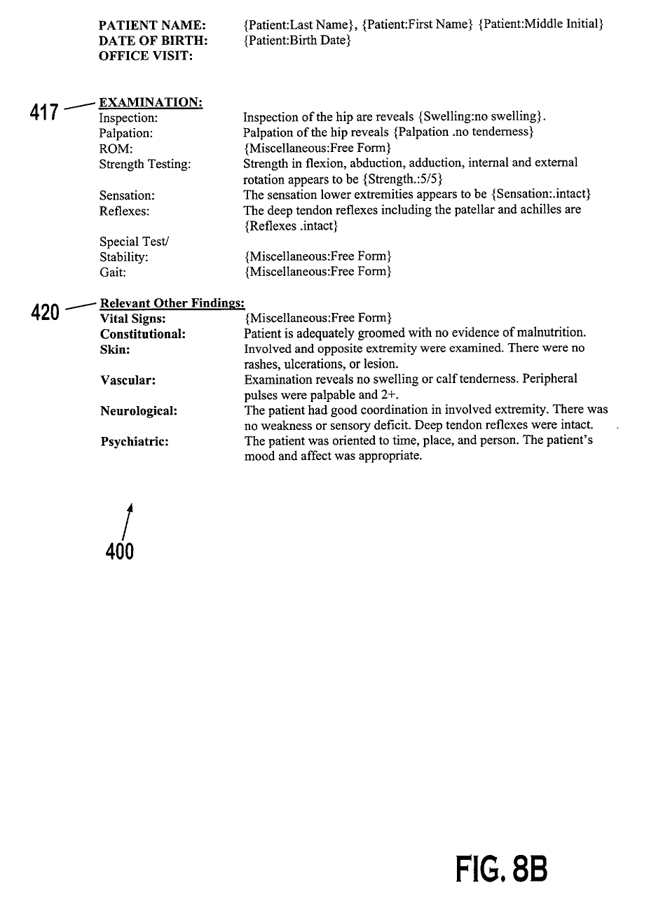

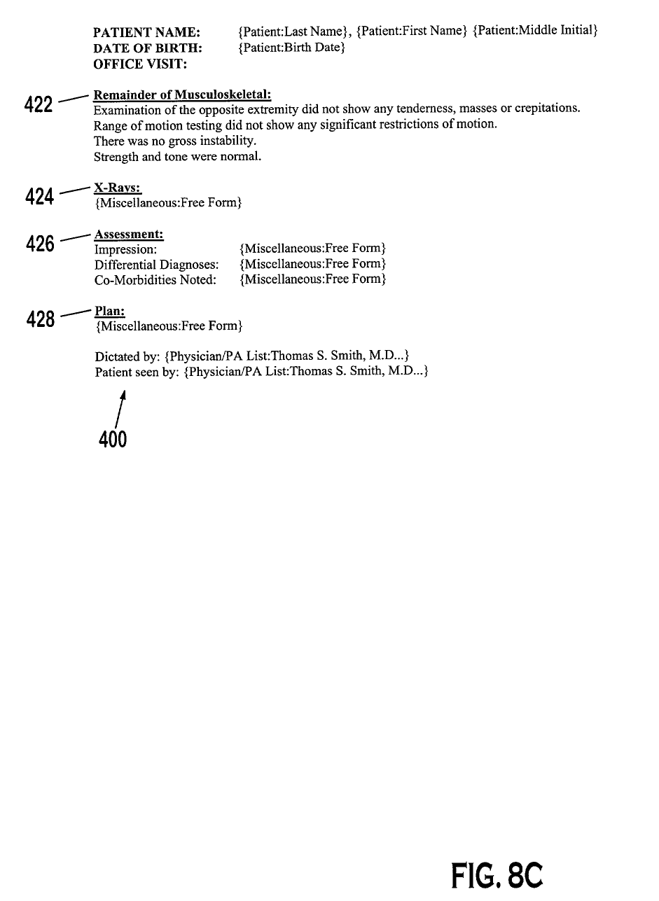

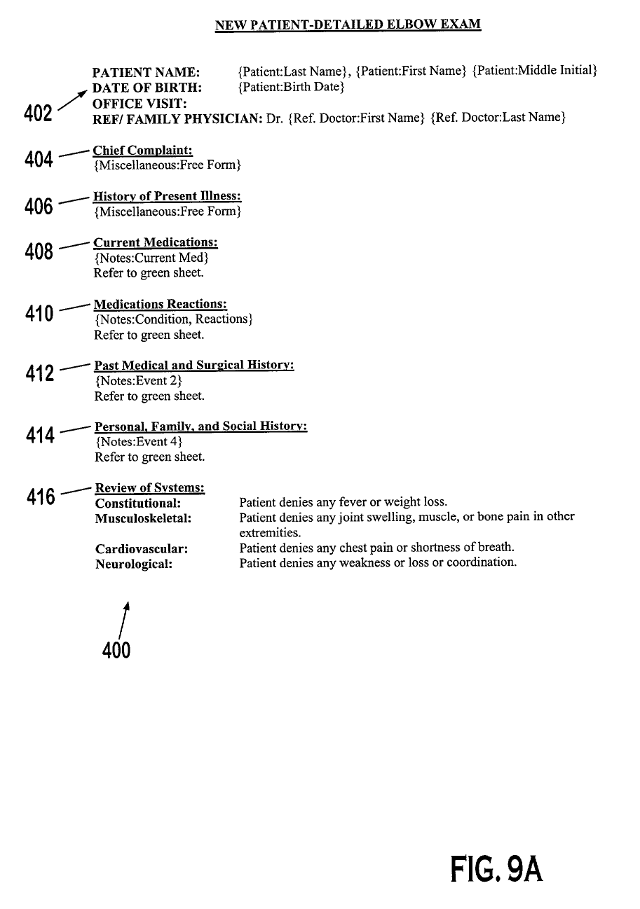

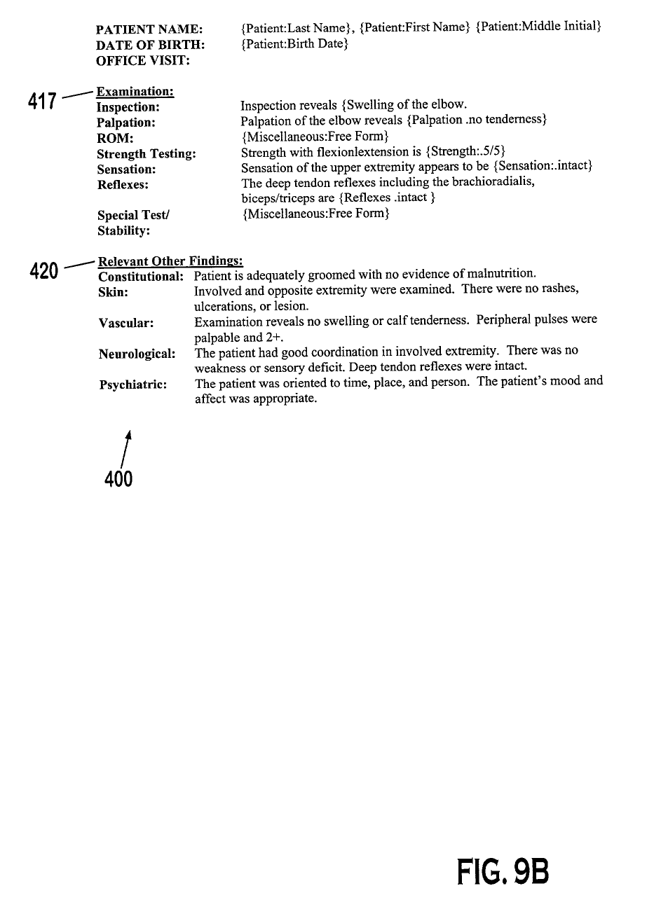

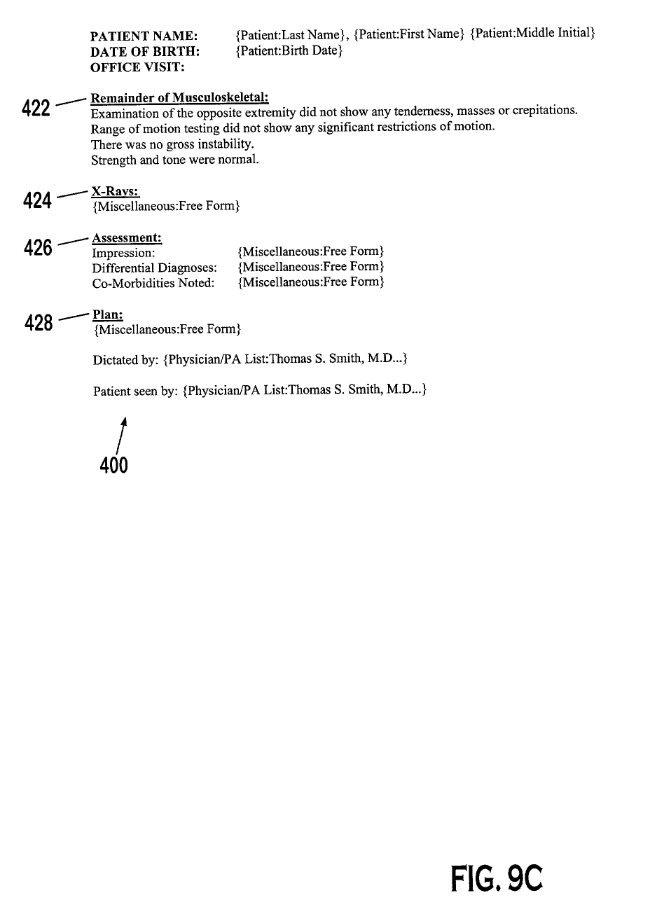

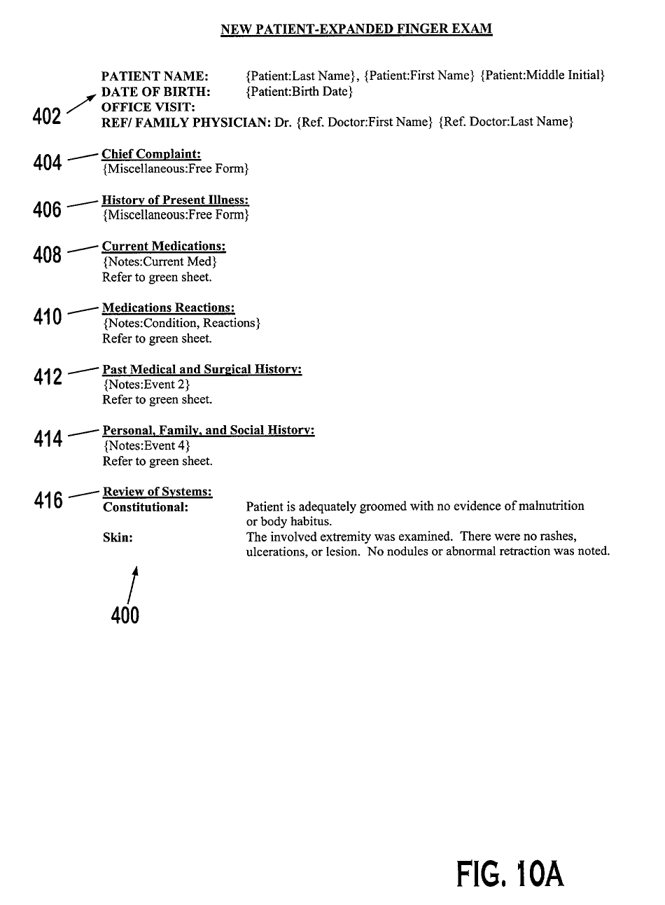

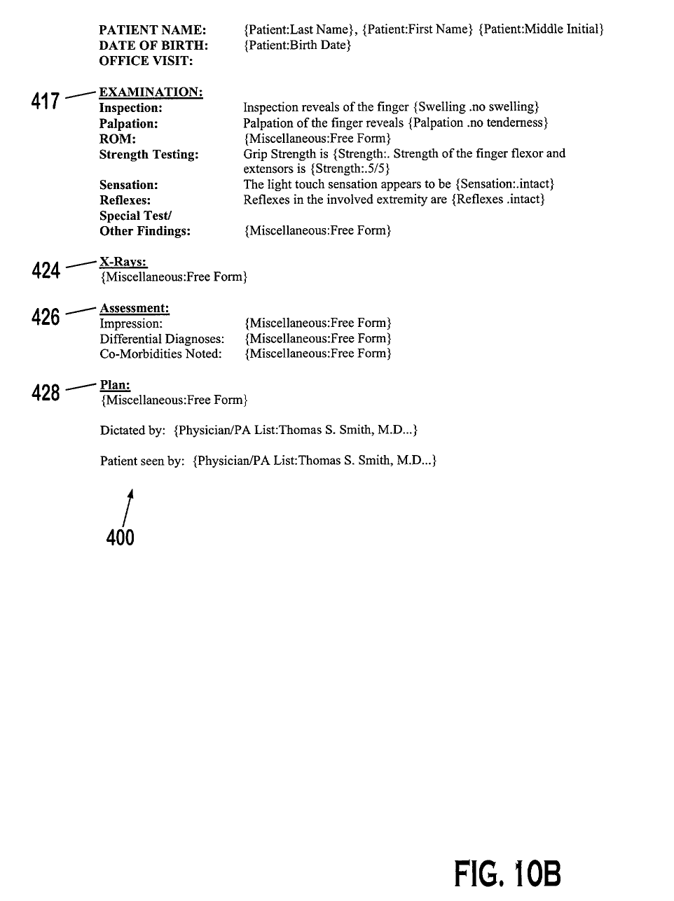

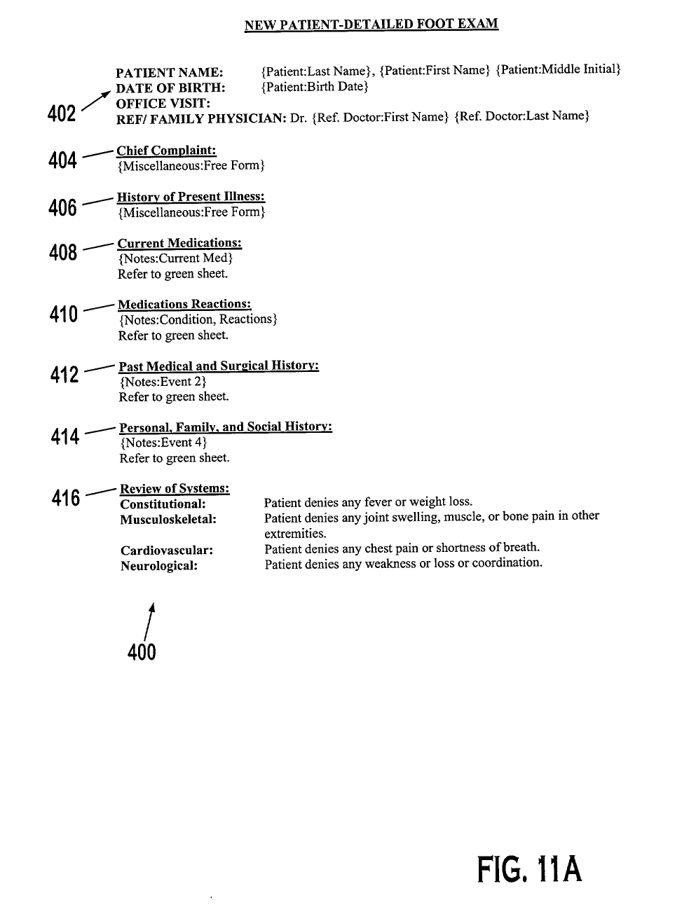

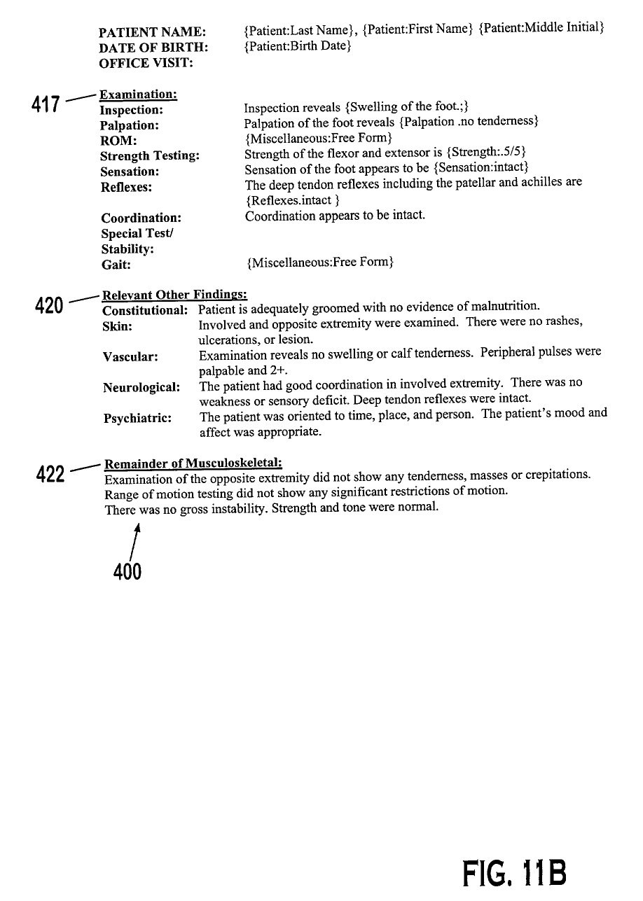

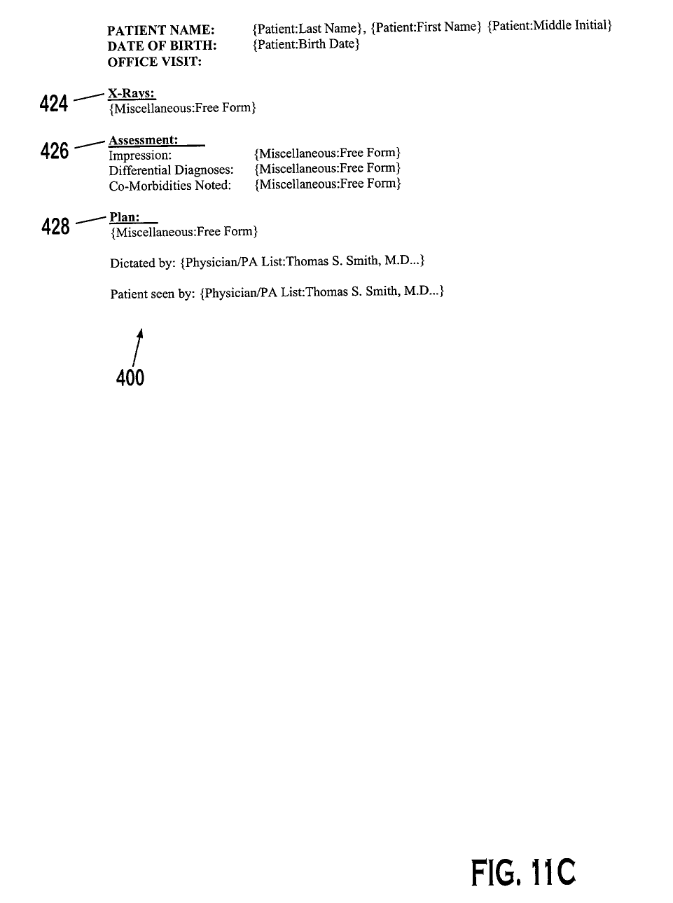

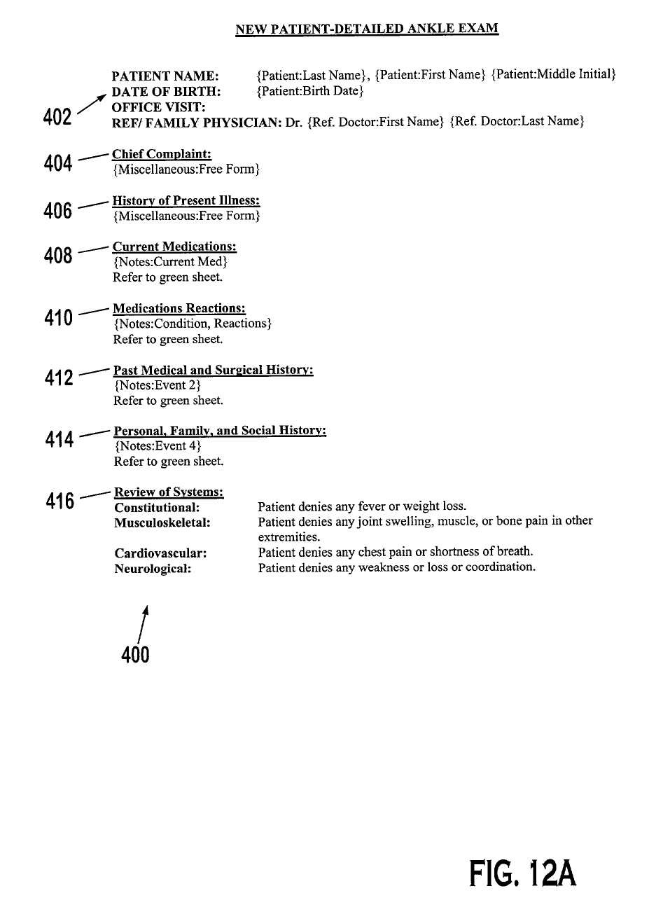

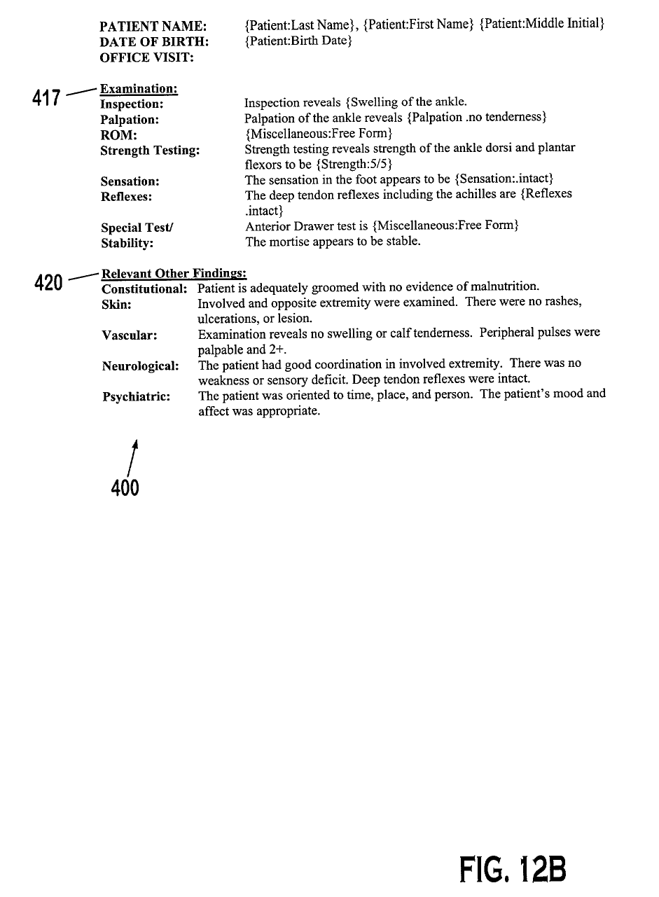

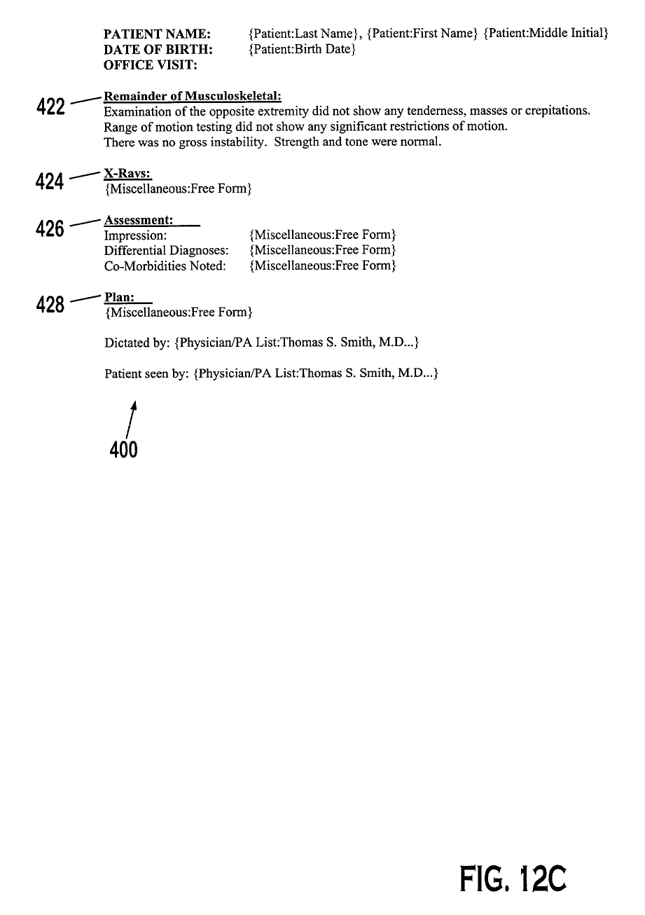

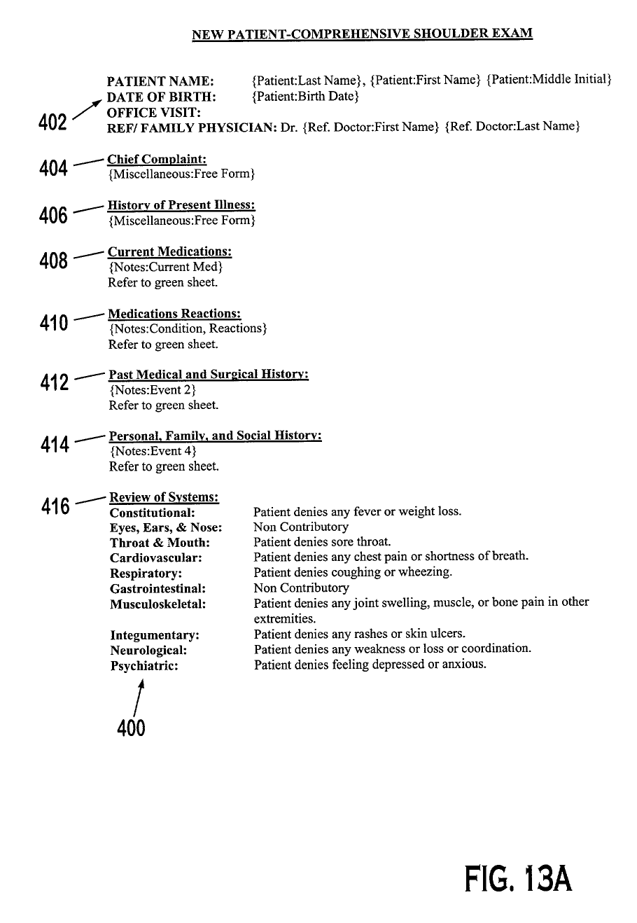

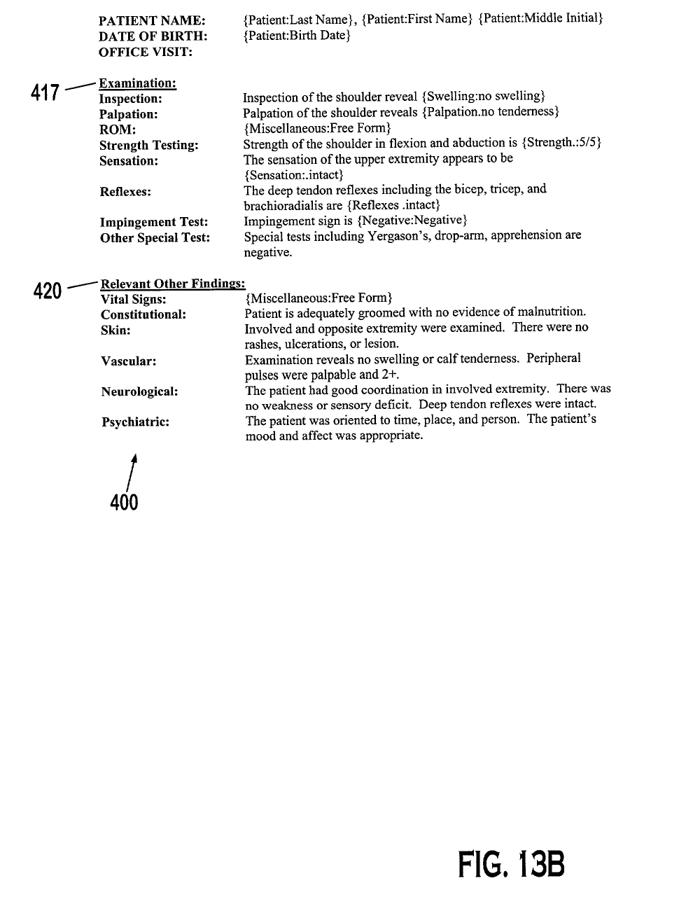

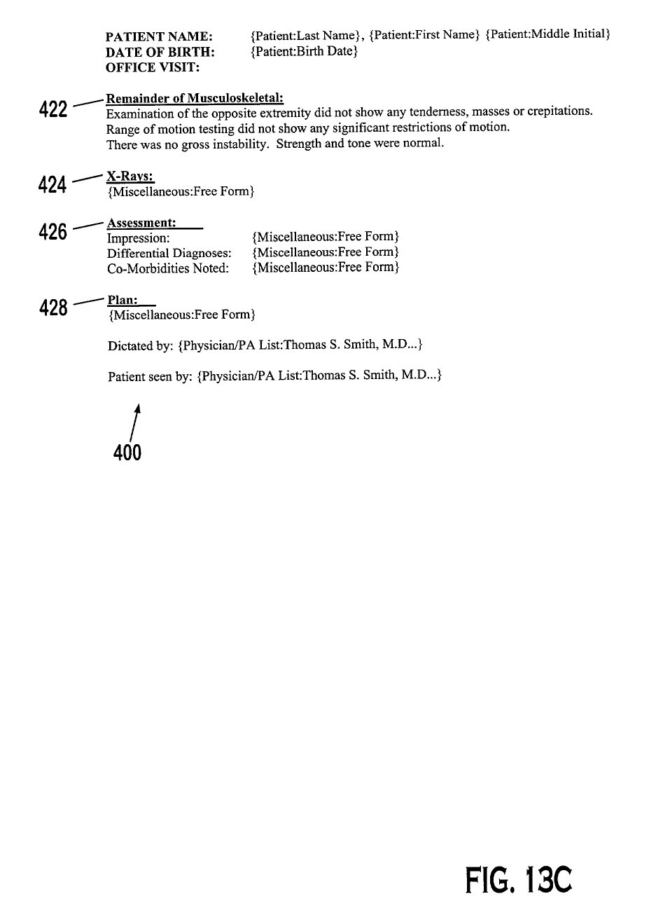

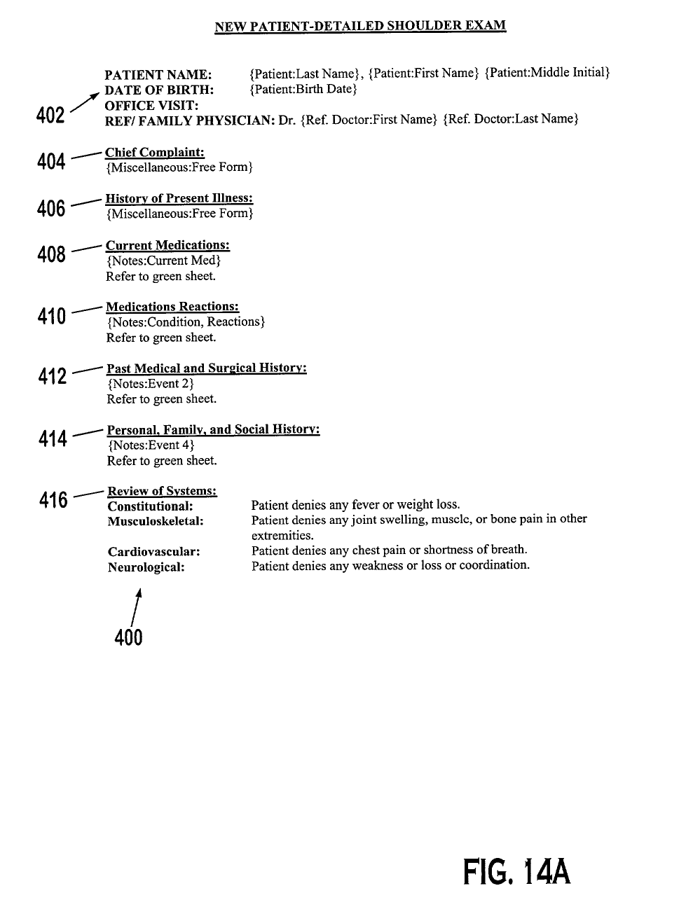

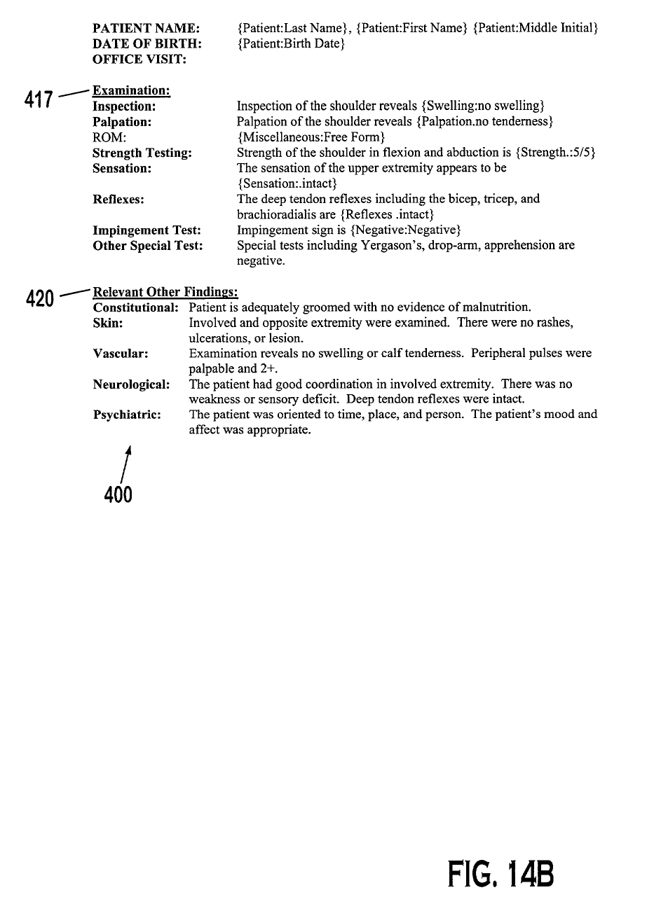

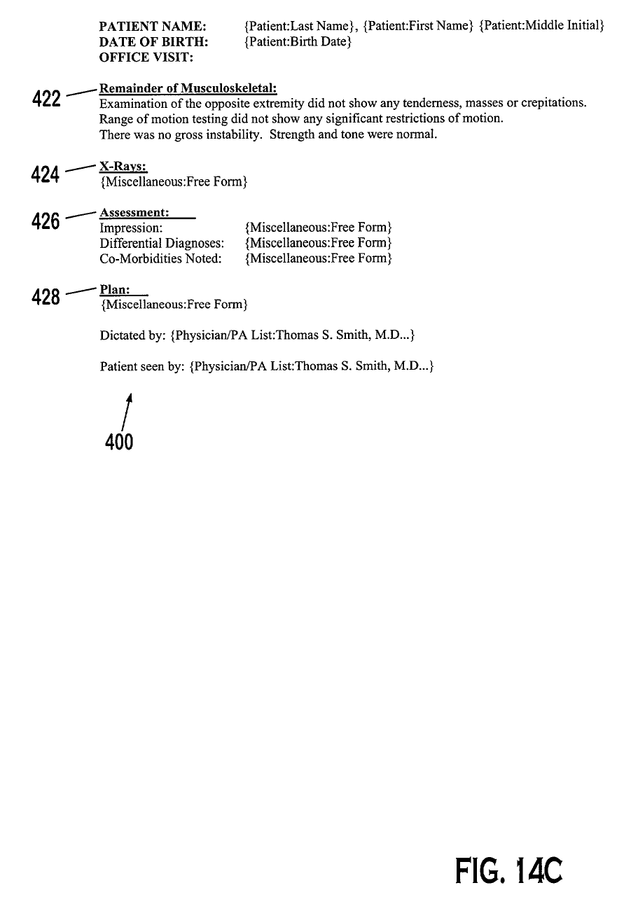

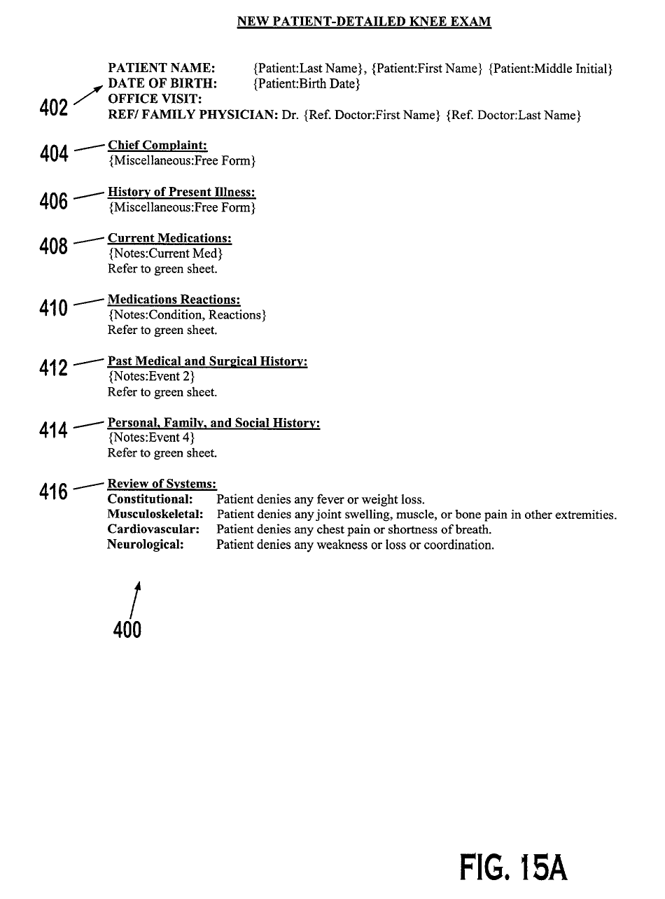

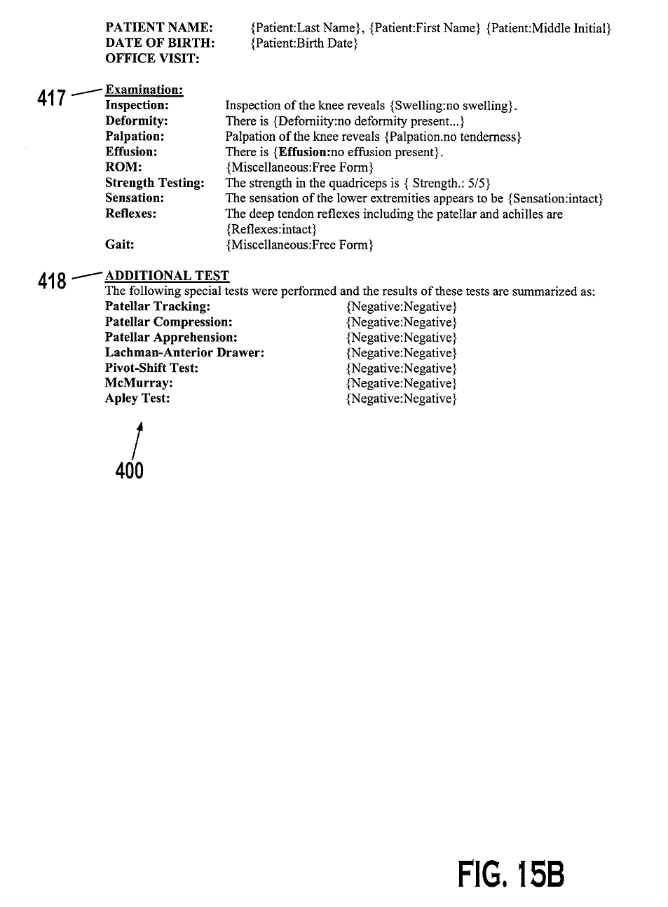

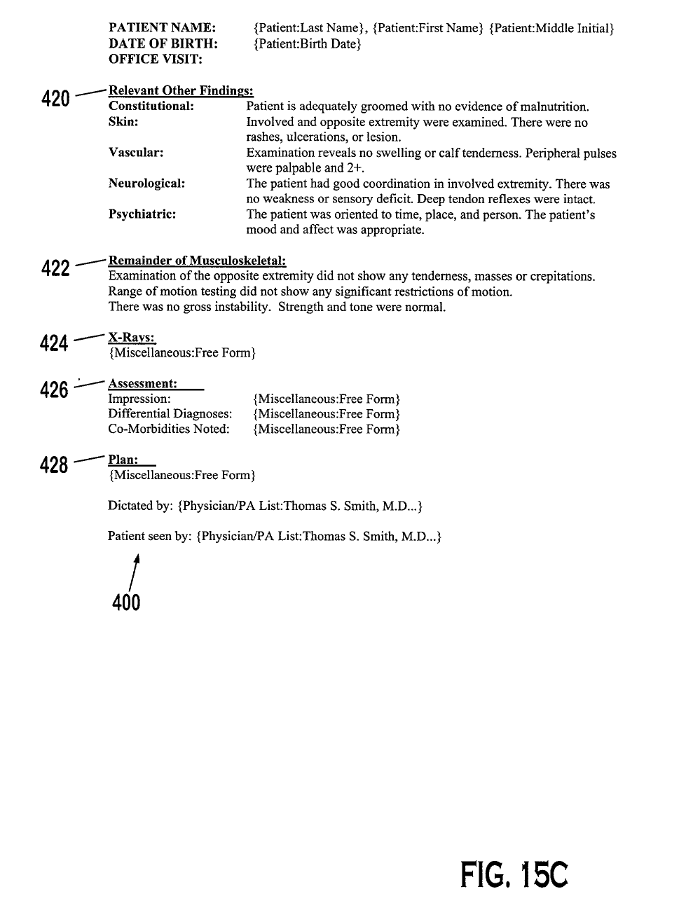

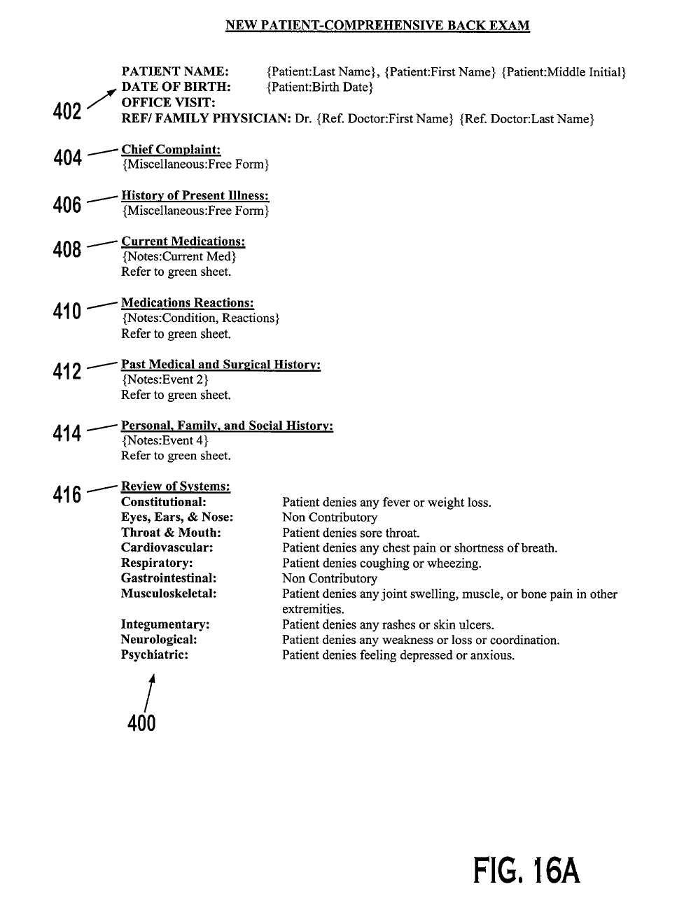

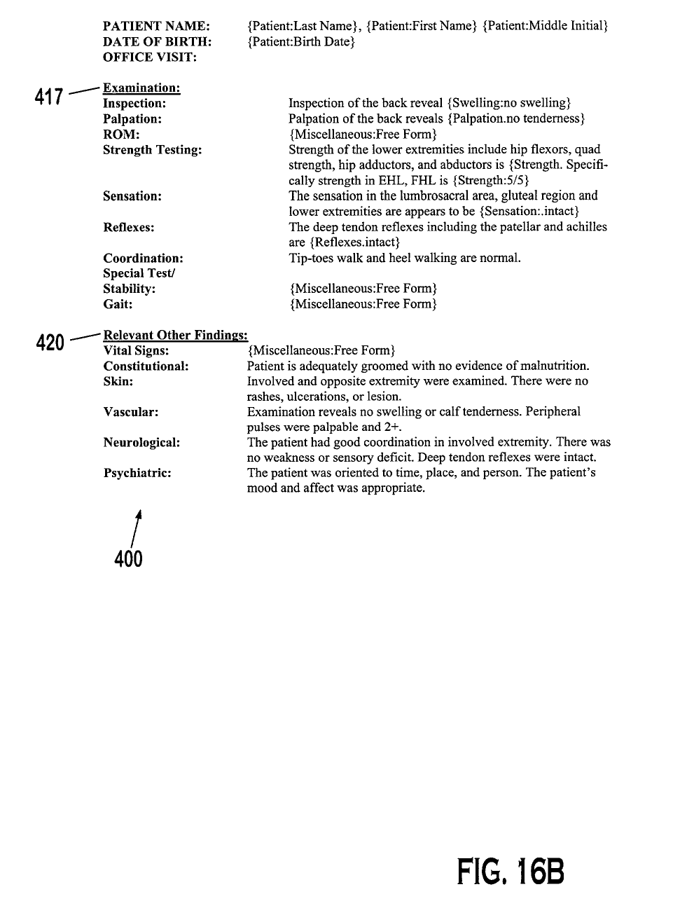

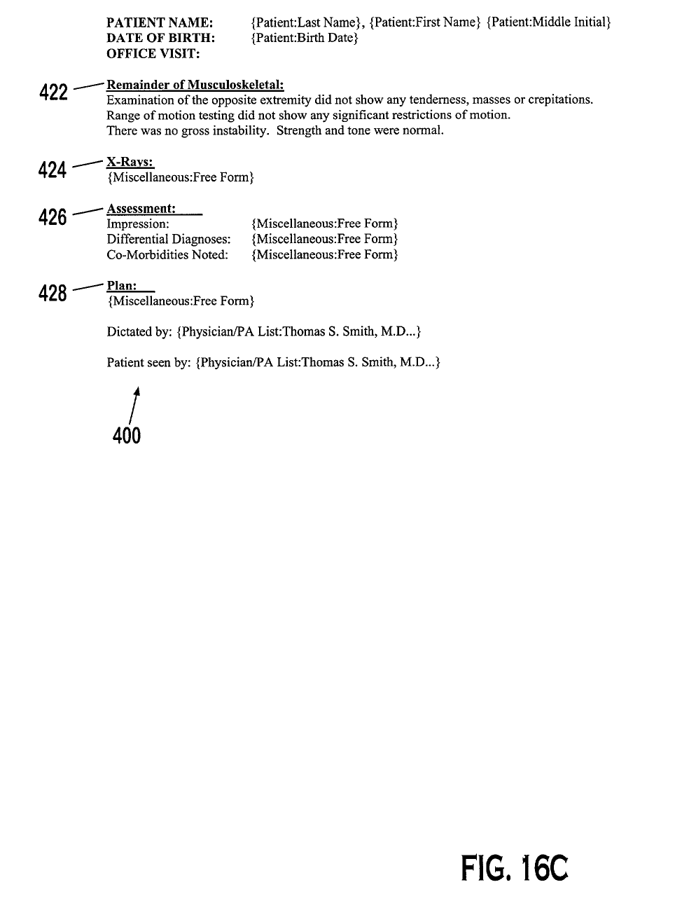

The medical transcription system 300 includes a variety of computer-based transcription templates 400 as shown in FIGS. 7A through 17C to save transcriptionist or secretarial time by allowing the transcriptionist to use the doctor's dictated tapes to complete the patient records quickly by using a large number of default values for fields that are common to most patients. The output of the medical transcription system is a patient medical record detailing the medical examination. The probability that the patient medical record complies with the Medicare requirements is higher than if the medical treatment template 100 and the medical transcription system 300 had not been used. The medical transcription system 300 and the medical treatment template 100 may both be considered as interfacing with each other to assist the doctor, and the transcriptionist, in producing a Medicare compliant patient medical record.

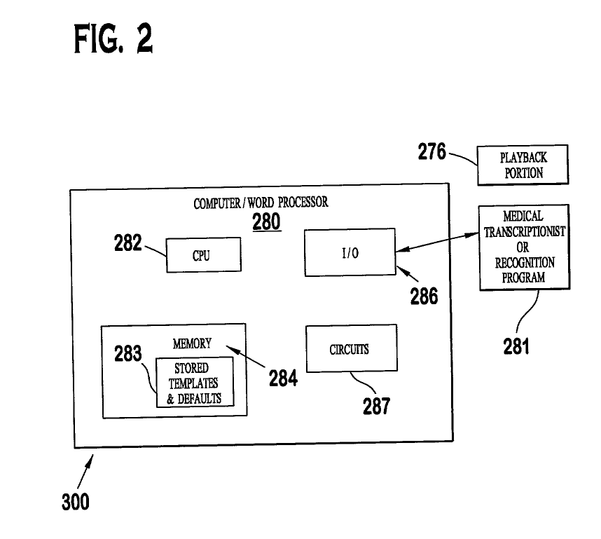

One embodiment of the block diagram of a medical transcription system 300 is shown in FIG. 2. The medical transcription system includes a tape playback portion 276 in which the medical transcriptionist plays back the tape previously dictated by the doctor (the doctor used the medical treatment template 100 during dictation). The medical transcription system 300 further includes a computer/word processor 280 that is configured so that the medical transcriptionist can insert the dictated values in a previously generated blank document. One embodiment of the blank document is shown in FIGS. 7A, 7B, and 7C. The computer/word processor 280 may be configured as one of a wide variety of computers such as a personal computer, a laptop, a mainframe, a networked-computer, or any other computer that can perform word processing operations.

The computer/word processor portion 280 includes a programmable central processing unit (CPU) 282 that is operable with a memory 284 (e.g., RAM, ROM, hard disk and/or removable storage) and well-known support circuits 287 such as power supplies, clocks, cache, input/output (I/O) 286 and the like. By assessing software stored in the memory 284, the computer/word processor 282 is able to perform word-processing functions, namely retrieving the embodiment of blank document shown in FIGS. 7A, 7B, and 7C by completing the fields for optional values and letting the remainder of the values be the default values. The completed form then can be stored and accessed, as desired.

In one embodiment, the medical treatment template 100 allows the doctor to dictate to a tape recorder while the computer-based medical transcription system 300 is used by a transcriptionist in generating a copy of the resultant medical record. In another embodiment, the doctor can input data directly into the medical record using a combined computer-based medical treatment template 100 and medical transcription system 300 either by the doctor inputting data directly (typing) or by the doctor using a speech recognition program.

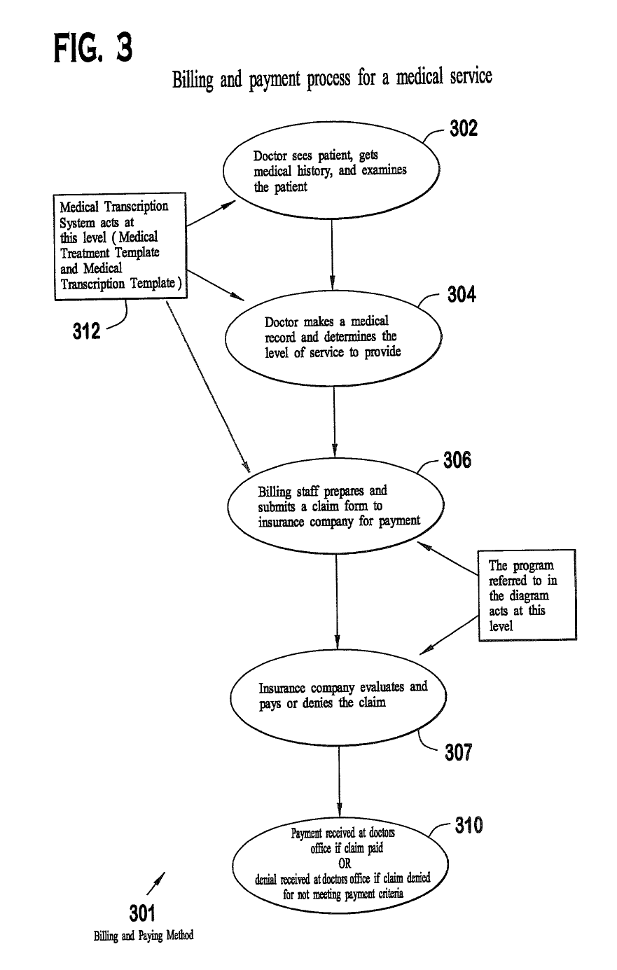

One embodiment of a billing and paying method 301 is shown in FIG. 3, which illustrates where one aspect of the medical treatment template 100 and the medical transcription system 300 may be applied. The billing and paying method 301 starts at step 302, where the doctor sees a patient, gets the patient's medical history, and examines the patient. Following step 302, the method continues to step 304 in which the doctor makes a medical record and determines the level of service to provide using template 100. Following step 304, the method continues to step 306 in which the billing staff prepares and submits a claim to the insurance company or Medicare office for payment.

Following step 306, the method continues to step 307 in which the insurance company or Medicare evaluates and pays or denies the claim. Following step 307, the method continues to step 310 in which payment is received at the doctor's office if the claim has been paid or the denial of payment is received at the doctor's office if the claim is denied for not meeting payment criteria. As indicated by 312, the medical treatment template 100 and the medical template system 300 are associated with steps 302, 304, and 306. As such, the combination of the medical treatment template 100 and the medical transcription system 300 is applied between when a doctor sees a patient, gets the patient's medical history, examines the patient, when the doctor determines the appropriate level of service and makes a medical record. In effect, the combination of the medical treatment template 100 and the medical transcription system 300 allows the doctor to efficiently determine the level of medical service to provide, and allows the medical transcriptionist to prepare patient records, from the information dictated by the doctor, that comply with Medicare or other insurance guidelines for that level of service.

The medical transcription system 300 allows transcriptionists (or the doctors themselves) to input what doctors dictate. The medical transcription system requires less time to produce a medical patient record using standard transcription systems since fewer fields have to be filled in by the medical transcriptionist. The medical transcriptionist inputs clinical information (including the patient's name, address, etc.). The medical transcriptionist also inputs the medical service provided by the doctor. The medical transcription system therefore relates to documenting both the elements of service that are identified using the medical treatment template 100 and clinical information that is input into the computer/word processor.

When using the medical transcription system 300, the medical transcriptionist inputs the information the doctor has documented into a computer/word processor 280. Recall that a doctor using the medical treatment template 100 dictates only the distinct patient fields and those fields for which there is positive, or non-default, information. The doctor does not have to dictate (and typically will not dictate) those fields where the patients' condition matches the negative (i.e. normal default) value. Therefore, the amount of time required for a doctor to dictate a patient record based on the combined medical treatment template 100 and medical transcription system 300 is a fraction of the time that the doctor would dictate a complete patient medical record using other techniques.

Each transcription template 400 in the medical transcription system 300 shown in FIGS. 7A through 17C is directed to a particular level of injury at a particular body part. For example, one transcription template may relate to a level three (detailed) knee transcription template. The complete set of transcription templates 400 are stored in the computer/word processor 280, and any particular transcription template may be recalled by the transcriptionist as needed. The transcriptionist can then complete that particular transcription template, save the template as a new file to produce an electronic patient record and/or may print out a document based on the electronic document to produce a hard copy of the record.

Each set of medical transcription templates 400 corresponds in order of inputs to the corresponding medical treatment template 100. For example, the first field listed in the embodiment of medical treatment template 100 shown in FIG. 1B is the demographics portion 104, followed by the chief complaint portion 106, and then the history of the present illness portion 108. The fields for each template from the set of medical transcription templates 400 must correspond to the order of the portions in the medical treatment template. The embodiments of medical transcription template shown in FIGS. 7A through 17C therefore include a demographics field 402, a chief complaint field 404, a history of present illness field 406, a current medications field 408, a medications reactions field 410, a past medical and surgical history field 412, a personal, family, and social history field 414, a review of systems field 416, an examination field 417, an additional test field 418, a relevant other finding field 420, a remainder of muscloskeletal field 422, an X-rays field 424, an assessment field 426, and a plan field 428.

The transcriptionist inputs data into the demographics field 402 that corresponds to the demographics portion 104 that the doctor dictated in the exam-level portion 101 of the medical treatment template 100. Similarly, the transcriptionist inputs data into the chief complaint field 404 that corresponds to the chief complaint portion 106 that the doctor dictated in the exam-level portion 101 of the medical treatment template 100. The transcriptionist inputs data into the history of present illness field 406 that the doctor dictated in the history of present illness portion 108 in the exam-level portion 101 of the medical treatment template 100.

The transcriptionist inputs data into the applicable one of the current medications field 408, the medications reactions field 410, the past medical and surgical history field 412 as well as the personal, family, and social history field 414 that corresponds to the dictation that the doctor dictated in the review the following portion 110 in the exam-level portion 101 of the medical treatment template 100. The transcriptionist inputs data into the review of systems field 416 that the doctor dictated in the a dictate portion 112 (that corresponds to the table shown in 119 in the exam-level portion 101 of the medical treatment template 100. The transcriptionist inputs data into the examination field 417 that corresponds to the doctor's dictation in the orthopedic examination portion 114 in the exam-level portion 101 of the medical treatment template 100.

The transcriptionist inputs data into the additional test field 418 that corresponds to the doctors dictation in the remainder of muscloskeletal portion 116. The transcriptionist inputs data into the relevant other finding field 420 that corresponds to the doctors dictation in the relevant other findings portion 118 in the exam-level portion 101 of the medical treatment template 100. The transcriptionist inputs data into the remainder of muscloskeletal field 422 that corresponds to the doctors dictation in the remainder of muscloskeletal portion 116 in the exam-level portion 101 of the medical treatment template 100.

The transcriptionist inputs data into the X-rays field 424 that corresponds to the doctors dictation in the X-rays portion 120 in the exam-level portion 101 of the medical treatment template 100. The transcriptionist transcribes data into the assessment field 426 that corresponds to the doctors dictation in the impression differential diagnosis portion 122 in the exam-level portion 101 of the medical treatment template 100. The transcriptionist inputs data into the plan field 428 that corresponds to the doctors dictation in the plan portion 124 in the exam-level portion 101 of the medical treatment template 100.

Each one of the fields 402, 404, 406, 408, 410, 412, 414, 416, 417, 418, 420, 422, 424, 426, or 428 of the embodiments of medical transcription template shown in FIGS. 7A through 17C relate to the corresponding portions 104, 106, 108, 110, 112, 114, 116, 118, 120, 122, 124, 126, 128, 130, 132, 134, or 136 in the exam-level portion 101 of the medical treatment template 100. In particular, each medical transcription template will include fields of the corresponding level of portions. For instance, there is a remainder of muscloskeletal field 422 in the medical transcription template shown in FIGS. 7A through 17C that corresponds to the remainder of muscloskeletal portion 116 in the exam-level portion 101 of the medical treatment template 100 in only those medical transcription templates that are detailed (level three) and comprehensive (level four). The remainder of muscloskeletal portion 116 is omitted from level two exams because they relate to level three and above portion exams. Therefore, any one of the medical transcription templates shown in FIGS. 7A through 17C that relate to level two (expanded) examinations will not include the “remainder of muscloskeletal” field 422. Similarly, any portion, or segment of a portion, that corresponds to the level four (comprehensive) portions of the medical treatment template 100 will be included only in those medical transcription templates shown in FIGS. 7A through 17C that relate to level four and above exams.

Certain one of the fields of the medical transcription templates shown in FIGS. 7A through 17C are shown as bracketed fields included between the open brackets “{” and the closed brackets “}”. The bracketed fields include text that include the default values (if any exist) as well as the general description of any free-form fields. Any other type of text highlighting technique may also be used. The brackets typically are not included in the output text of the patient record. If the medical transcriptionist does not type over any default field, then only the default value of the default field will exist. However, if the medical transcriptionist types over a default field, then only the typed-over text will be displayed in the patient record. The free-form fields require the medical transcriptionist to overtype the field with some value. For instance, the demographics field is an example of a primarily free-form field where the transcriptionist has to input the patient's name, address, etc.

The medical transcription templates shown in FIGS. 7A through 17C are intended to be illustrative, and not limiting, in scope. In a similar manner that the medical treatment template 100 may be directed to different types of medical exams, treatments, and the likes, each medical transcription templates must be tailored to a particular medical treatment template 100. For example, the order of the fields in the medical transcription template must correspond to the order of the portions in the medical treatment template 100.

The data input in the medical transcription system (i.e. stored in a computer or a network or printed out to a hard copy) may be considered as providing a patient record that describes the treatment in a Medicare-compliant manner. The doctor will consider the completed form and sign the output of the medical transcription system if it is acceptable. The doctor returns the form with changes if it is not acceptable by the doctor. This form is referred to as an initial intake, as compared to the above described “green sheet” which is a medical patient intake form. The documentation by the doctor certifies that the doctor has looked at the intake, and the doctor has considered the intake in the medical decision. The doctor doesn't have to enter the initial intake, as long as the doctor has reviewed the initial intake.

Using the medical treatment template 100-based system is easier for both the doctor and the medical transcriptionist by limiting the number of default fields that are respectively dictated and input. The system only inputs information in a field if findings differ from the normal default values. Assume that a patient's exam entirely agrees with the default values, the only items that the medical transcriptionist would complete would be such patient particulars as their name, address, etc., and quantifiable values such as range of motion. The medical transcriptionist does not have to type anything for default values. That is why little transcription is necessary using the medical transcription system 300. The doctor dictates just those fields that relate to a positive finding such as an injury, non-normal condition, or routine required field such as name or blood pressure. These fields typically require that the transcriptionist inputs some input value that differs from the default values. If the doctor does not find any positive finding, the only things found in the exam may be limited range of motion, personal information, and the like. The doctor only transcribes non-default values except for range of motion, and such quantifiable exam results. The necessary dictation and transcription necessary for the exam is therefore limited to the positive results, the quantifiable inputs, and the personal information. Doctors will thus find office visits easier to document.

The transcriptionist thus transcribes the positive findings and personal information of the final patient report with most of the fields being completed in their normal or default state. Only the non-normal fields have to be dictated by the doctors and transcribed by transcriptionist. That is why the medical transcription system saves so much time compared to other systems where all the fields (for positive and negative findings) have to be completed. The medical transcription system 300 can be configured to include any software that allows for default values to be inserted.

The documentation merging of the medical transcription template allows for all the default fields to be formed in a manner to be limited only by the positive findings. In the embodiment described herein, sixty three items are documented for a level four exam. Because of the large number of positive and negative findings, a majority of doctors cannot recite from memory each of the 63 elements included in the medical treatment template and the medical transcription system. This lack of ability of the doctors to be able to recite each negative and positive finding is not only because of the large number of total findings, but because the doctor's time and effort is focused on the positive findings instead of the negative findings (doctors concentrate on what is wrong with a patient). A doctor will naturally note if a patient is in a great deal of pain as indicated by the patients grimacing or crying, for example when a doctor examines and interviews a patient. The doctor will also be able to similarly detect if a patient is alert, has evidence of significant depression, exhibits anorexia, or a variety of other findings by their outward appearance or behavior. These detections of the positive findings will occur naturally based on doctors perceptions and trainings. However, a doctor may not necessarily recall that they have to examine a particular patient for all of the large number of negative findings such as alertness, significant depression, etc. to satisfy Medicare guidelines if none of these negative findings are exhibited. Doctors using dictation often do not provide Medicate compliant patient reports since they do not document the negative findings.

The medical transcription template 400 provides a system in which all of the findings (positive and negative) are automatically integrated into the final report. The medical treatment templates 100 can be modified to concur with the latest Medicare guideline. As such, the combination of the doctors dictating using the medical treatment template 100 and the transcriptionist inserting the data into the appropriate default and non-default fields of the medical transcription template 400 limit the surprise of forgetting to provide necessary fields to satisfy the Medicare guidelines. The combination of the medical treatment template and the medical transcription system acts to document the positive findings to produce the patient record. A Medicare compliant exam patient record (that can include a large number of pages, such as 6 or 10) can thus be produced by documenting data into a very small number of fields.

While the medical transcription template 400 is described as being completed by a medical transcriptionist, it is envisioned that speech recognition programs where spoken words are converted to text may be used where the doctor's voice is converted into text data in the transcription templates 400 by the doctor or another person. In these embodiments, the person operating the medical transcription system 300 may indicate the particular field on the transcription templates 400 to access, and the voice from the doctor can be input directly as text from the program to the pertinent field. Alternately, the doctor can indicate the field to be dictated, dictate the text, and have another individual complete the remainder of the form. Since the doctor using the medical treatment template 100 is dictating only default values, the field can be accessed by the doctor dictating the name of the field followed by the inserted speech text. A doctor dictating directly into the medical transcription system 300 operating on the computer 280 shown in FIG. 2 may, for example, dictate something similar to the following for a patient with a knee injury:

(a) The doctor dictates the word “demographics” followed by the particular patient demographic information. The dictation of the word “demographics” translates the cursor to the demographics portion of the medical transcription template 400. The input demographics portion types the text, using a suitable speech recognition program, into the appropriate demographics field in the medical transcription template;

(b) The doctor then dictates the word “chief complaint” followed by the chief complaint as indicated by the patient. The dictation of the word “chief complaint” translates the cursor to the chief complaint portion of the medical transcription template 400. The input demographics portion types the text, using a suitable speech recognition program, into the appropriate chief complaint field in the medical transcription template; and

(c) The doctor then dictates the word “examination” followed by the particular non-default values, such as “right knee is swollen with apparent cartilage problems. The dictation of the word “examination” translates the cursor to the examination portion of the medical transcription template 400. The input demographics portion types the text, using a suitable speech recognition program, into the appropriate examination field in the medical transcription template.” The remainder of the fields in the medical transcription template could be completed using an embodiment of medical transcription system 300 including a speech recognition program.

This portion of the disclosure describes how different embodiments of medical transcription system 300 may allow a medical transcriptionist, secretary, or other person skilled in word processing to input text into computer based transcription templates 400 included in the embodiment of computer based medical transcription system 300 show in FIG. 2. Not only is the text input efficiently using the medical transcription system 300, but the use of default fields in the computer based transcription templates 400 and associated medical treatment template 100 allows for Medicare compliant patient records to be effectively, and efficiently, produced.

III. Letter Generation

While the principles of the invention have been described above in connection with the specific apparatus and associated method, it is to be clearly understood that this description is made only by way of example and not as a limitation on the scope of the invention.

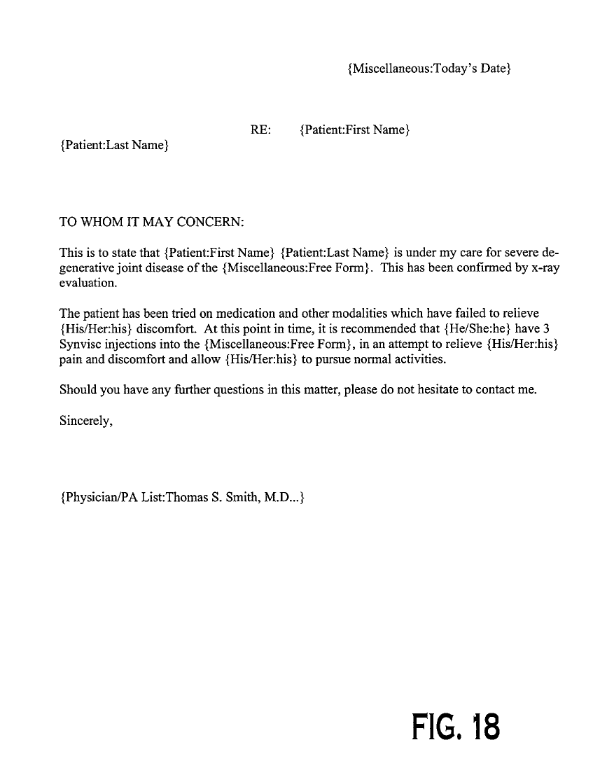

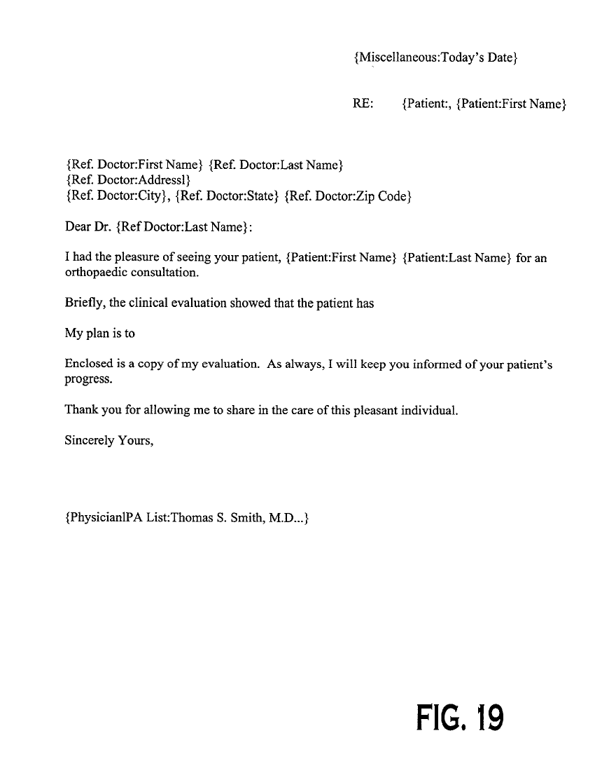

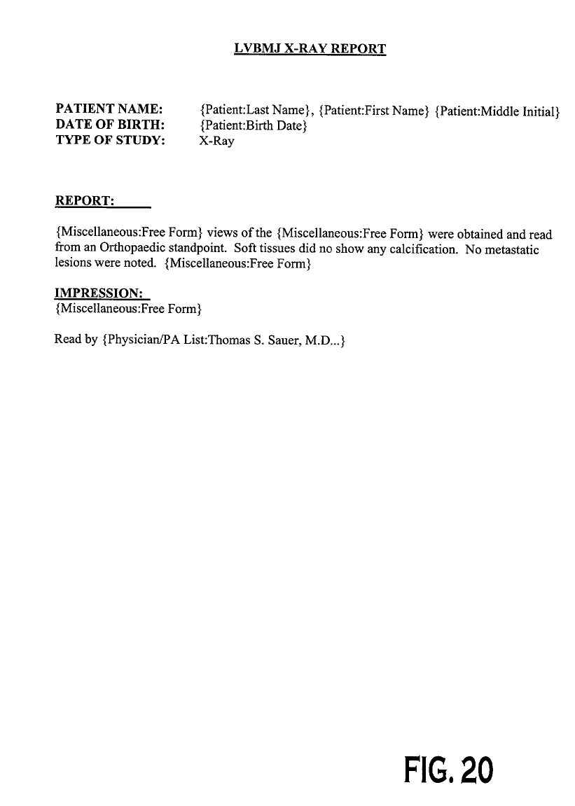

The embodiments of medical treatment templates 100 and the associated medical transcription template 400, described herein, together provide for the efficient generation of Medicare compliant patient records. However, it is also to be understood that various types of letters can be generated effectively using the data input to the medical transcription system 300 as described above. Many of these letters tend to be routine letters that are sent out to various individuals or groups as a result of the examination. Examples of such letters include, but are not limited to, letters of care such as shown in the embodiment of FIG. 18; referral letters, such as shown in the embodiment of FIG. 19; X-ray report letters, one embodiment shown in FIG. 20; and a variety of other similar types of letters that are well known in the medical profession.

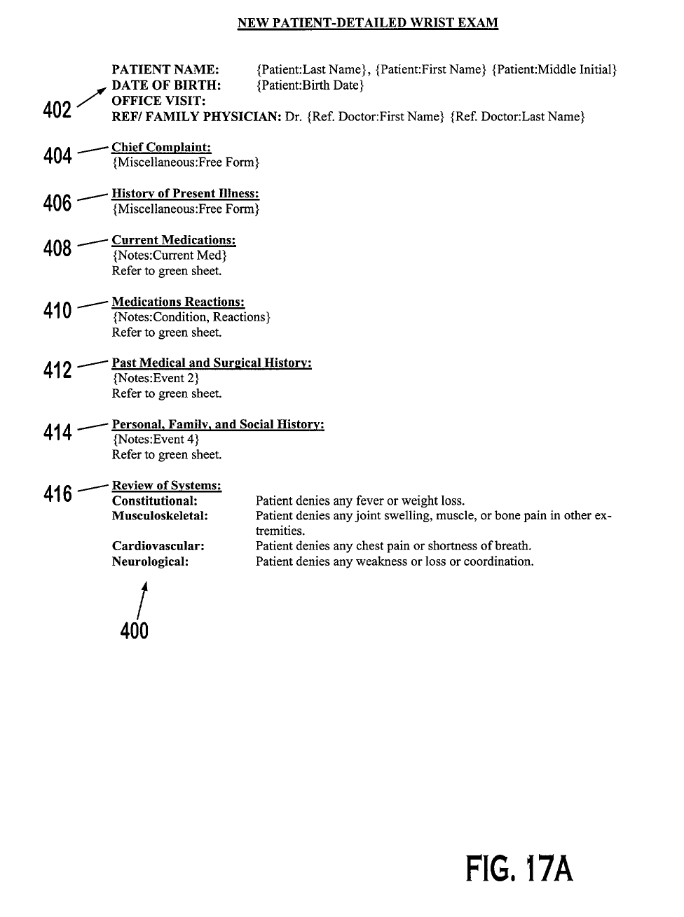

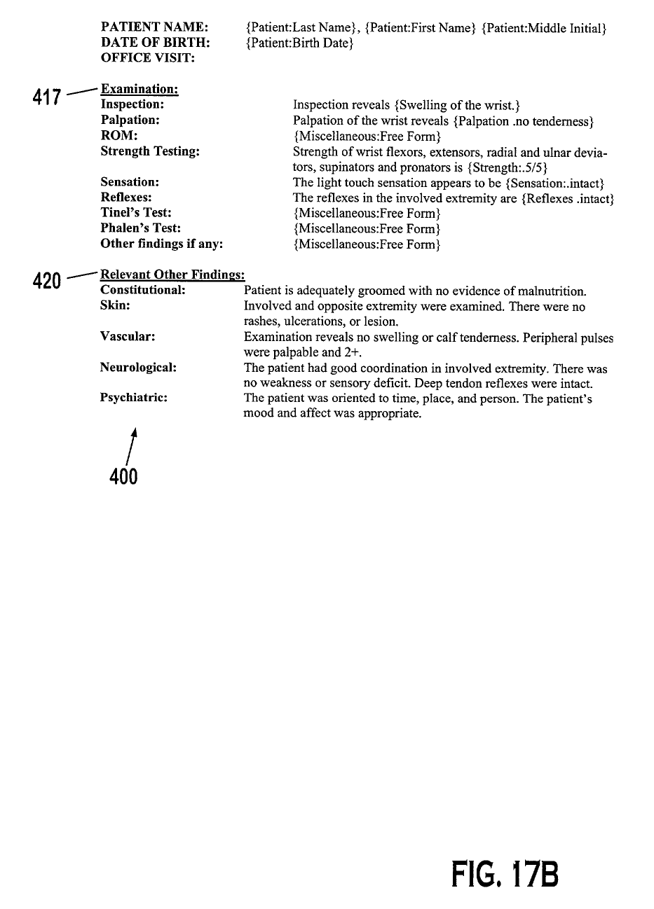

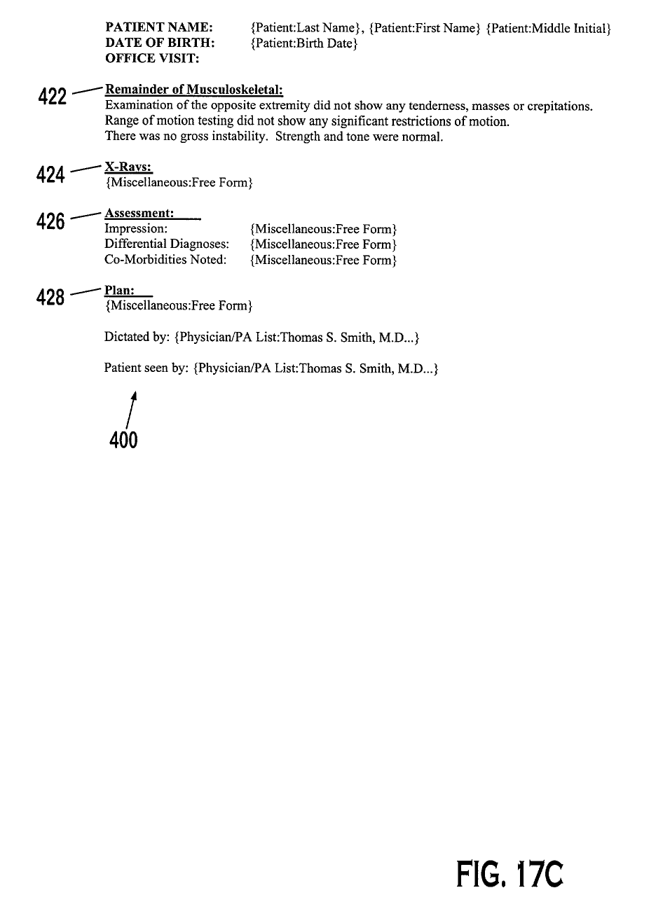

In one embodiment in which the letters are generated using the medical transcription system 300, the transcriptionist, typist, or secretary only has to input the information relating to a prescribed answer to a prescribed field into all of the letters or records associated with a single patient record once. For instance, a doctor dictating into the demographics portion 104 of the exam portion 101 of the medical treatment template 100 will dictate the patient's name, date seen, date dictated, and similar fields. The medical transcriptionist will type the information corresponding to the patient's name into the corresponding bracketed portion of the transcription template 400. Similar data is input to letters such as referral, x-ray billing, etc. Since the bracketed portions in the transcription template 400 represent fields, these fields as modified by the transcriptionist can be applied directly to the letters, certain embodiments of which are shown in FIGS. 17 to 20. A secretary or typist does not have to insert matter that has been previously been inserted into the patient records into the corresponding fields of the transcription template 400 by the transcriptionist. The possibility of errors produced by such reinsertion of text between multiple documents (the letters and the transcription templates 400) is limited. The generation of letters is a very time consuming process in the medical field. For example, an examination, in which the doctor typically bills from five (5) minutes to twenty (20) minutes, may result in a production of from ten (10) to twenty (20) letters of one type to another relating to x-rays, referrals, treatment, and the like. If such fields as the documentation fields could be made to apply consistently between multiple medical records and letters, the effort and time that the doctors have to apply to checking for errors could be greatly reduced. Utilizing the fields of the transcription templates to generate letters in addition to the patient records results not only in time-saving, but production of more correct documents.

While the principles of the invention have been described above in connection with the specific apparatus and associated method, it is to be clearly understood that this description is made only by way of example and not as a limitation on the scope of the invention.

1. A method for generating a patient record that is compliant with insurance guidelines, the insurance guidelines including a plurality of service levels associated with patient care wherein each of the different service levels affords a health care provider a different amount of reimbursement, the method comprising the steps of:
(A) receiving answers to a patient intake questionnaire;
(B) determining a service level applicable to a patient encounter by applying objective rules to the questionnaire answers, wherein the objective rules identify a service level that maximizes the amount of reimbursement associated with the patient encounter;
(C) applying the determined service to a medical treatment template in order to identify elements of service to be provided to the patient during the encounter;
(D) providing the identified elements of service to the patient during the encounter;
(E) after the encounter, documenting the identified elements of service provided to the patient; and
(F) forming the compliant patient record by inputting reimbursement information documented in step (E) into a computer system, wherein the reimbursement information corresponding to the patient encounter is only inputted into the computer system after at least steps (A) to (C) have been performed.

2. The method of claim 1, wherein the insurance guidelines are Medicare guidelines.

3. A method for generating a compliant patient record that is compliant with insurance guidelines, the method comprising:
providing a medical transcription system that includes a plurality of fields that may be filled with either a default value or a non-default value;
providing a template for a doctor to view the default values for each one of said plurality of fields, the default values for each one of said plurality of fields may vary based on an exam level;
dictating the non-default values for each one of said plurality of fields where the default value is inappropriate;
inputting the non-default values, and allowing the medical transcription system to input the default values, in the medical transcription system; and
generating the compliant patient record.

4. The medical of claim 3, wherein the doctor dictates the non-default values.

5. The method of claim 3, wherein a medical transcriptionist inputs the non-default values.

6. The method of claim 3, wherein the medical transcription system generates the compliant patient record.

7. The method of claim 3, wherein the template includes a medical treatment template.

8. The method of claim 3, wherein the insurance guidelines include Medicare guidelines.

9. A method for generating a compliant patient record that is compliant with insurance guidelines using a medical transcription system that includes a plurality of fields that may be filled with either a default value or a non-default value, the method comprising:
providing a template for a doctor to view the default values for each one of said plurality of fields, the default values for each one of said plurality of fields may vary based on an exam level;
dictating the non-default values for each one of said plurality of fields where the default value is inappropriate.

10. The medical of claim 9, wherein the doctor dictates the non-default values.

11. The method of claim 9, wherein the template includes a medical treatment template.

12. The method of claim 9, wherein the insurance guidelines include Medicare guidelines.

13. A method for generating a compliant patient record that is compliant with insurance guidelines, in which a doctor relies on a template to view the default values for each one of a plurality of fields, the default values for each one of said plurality of fields may vary based on an exam level, the doctor dictating the non-default values for each one of said plurality of fields where the default value is inappropriate, the method comprising:
providing a medical transcription system that includes the plurality of fields that may be filled with either a default value or a non-default value, the default values for each one of said plurality of fields may vary based on an exam level;
inputting the non-default values, and allowing the medical transcription system to input the default values, in the medical transcription system; and
generating the compliant patient record.

14. The method of claim 13, wherein a medical transcriptionist inputs the non-default values.

15. The method of claim 13, wherein the medical transcription system generates the compliant patient record.

16. The method of claim 13, wherein the template includes a medical treatment template.

17. The method of claim 13, wherein the insurance guidelines include Medicare guidelines.

18. An apparatus for generating a patient record that is compliant with insurance guidelines, the insurance guidelines including a plurality of service levels associated with patient care wherein each of the different service levels affords a health care provider a different amount of reimbursement, the apparatus comprising:
means for receiving answers to a patient intake questionnaire;
means for determining a service level applicable to a patient encounter by applying objective rules to the questionnaire answers, wherein the objective rules identify a service level that maximizes the amount of reimbursement associated with the patient encounter;
means for applying the determined service to a medical treatment template in order to identify elements of service to be provided to the patient during the encounter;
means for providing the identified elements of service to the patient during the encounter;
means for documenting the identified elements of service provided to the patient following the encounter; and
means for forming the compliant patient record by inputting reimbursement information documented by said means for documenting into a computer system, wherein the reimbursement information corresponding to the patient encounter is only inputted into the computer system after at least the means for receiving answers, means for determining a service level applicable, and the means for applying the determined service to a medical treatment template have completed their respective functions.

19. An apparatus for generating a compliant patient record that is compliant with insurance guidelines, the apparatus comprising:
means for providing a medical transcription system that includes a plurality of fields that may be filled with either a default value or a non-default value;
means for providing a template for a doctor to view the default values for each one of said plurality of fields, the default values for each one of said plurality of fields may vary based on an exam level;
means for dictating the non-default values for each one of said plurality of fields where the default value is inappropriate;
means for inputting the non-default values, and allowing the medical transcription system to input the default values, in the medical transcription system; and
means for generating the compliant patient record.

20. A method for generating a compliant patient record that is compliant with insurance guidelines, the method comprising:
filling in a plurality of fields of a medical transcription system that may be filled with either a default value or a non-default value;
a doctor viewing the default values for each one of said plurality of fields in a template, the default values for each one of said plurality of fields may vary based on an exam level, wherein, using the template, a doctor can dictate the non-default values for each one of said plurality of fields where the default value is inappropriate;
inputting the non-default values using a medical transcription system including a computer;
allowing the medical transcription system to input the default values to be stored by the medical transcription system; and
generating the compliant patient record using the medical transcription system.

21. The method of claim 20, wherein the doctor dictates the non-default values.

22. The method of claim 20, wherein a medical transcriptionist inputs the non-default values.

23. The methods of claim 20, wherein the template includes a medical treatment template.

24. The method of claim 20, wherein the insurance guidelines include Medicare guidelines.

25. A business method for generating a compliant patient record that is compliant with insurance guidelines, the method comprising:
filling in a plurality of fields of a medical transcription system that may be filled with either a default value or a non-default value;
a doctor viewing the default values for each one of said plurality of fields in a template, the default values for each one of said plurality of fields may vary based on an exam level, wherein, using the template, a doctor can dictate the non-default values for each one of said plurality of fields where the default value is inappropriate;
inputting the non-default values using a medical transcription system including a computer;
allowing the medical transcription system to input the default values to be stored by the medical transcription system; and
generating the compliant patient record using the medical transcription system.

26. A method for generating a letter using a patient record that is compliant with insurance guidelines, the letter includes fields, the method comprising:
filling in a plurality of fields of a medical transcription system that may be filled with either a default value or a non-default value;
a doctor viewing the default values for each one of said plurality of fields in a template, the default values for each one of said plurality of fields may vary based on an exam level, wherein, using the template, a doctor can dictate the non-default values for each one of said plurality of fields where the default value is inappropriate;
inputting the non-default values using a medical transcription system including a computer;
allowing the medical transcription system to input the default values to be stored by the medical transcription system;
generating the compliant patient record using the medical transcription system;
applying the input default or non-default values into the fields of the letter; and
generating the letter including the default fields.

27. A business method for generating a patient record that is compliant with insurance guidelines, the insurance guidelines including a plurality of service levels associated with patient care wherein each of the different service levels affords a health care provider a different amount of reimbursement, the method comprising the steps of:
(A) receiving answers to a patient intake questionnaire;
(B) determining a service level applicable to a patient encounter by applying objective rules to the questionnaire answers, wherein the objective rules identify a service level that maximizes the amount of reimbursement associated with the patient encounter;
(C) applying the determined service to a medical treatment template in order to identify elements of service to be provided to the patient during the encounter;
(D) providing the identified elements of service to the patient during the encounter;
(E) after the encounter, documenting the identified elements of service provided to the patient; and
(F) forming the compliant patient record by inputting reimbursement information documented in step (E) into a computer system, wherein the reimbursement information corresponding to the patient encounter is only inputted into the computer system after at least steps (A) to (C) have been performed.

28. An exam level portion of a medical treatment template, comprising:
a plurality of portions that a doctor can use to dictate a Medicare-compliant medical record, certain ones of said portions include default values that represent a common value for said particular portion, wherein text relating to certain ones of said portions vary depending upon a level of examination.

29. The exam level portion of a medical treatment template of claim 28, wherein the text in a plurality of portions that vary depending upon the level of examination are all included within a single template.

30. The exam level portion of a medical treatment template of claim 29, wherein the text relating to one particular varying levels of examination is differentiated from text relating to another particular varying levels of examination.

31. The exam level portion of a medical treatment template of claim 30, wherein the text relating to the different varying levels of examination is differentiated using one of the group of highlighting, text coloring, text shading, and highlighting coloring.

32. The exam level portion of a medical treatment template of claim 28, wherein the text in a plurality of portions that vary depending upon the level of examination is each included within one of a plurality of templates.

33. The exam level portion of a medical treatment template of claim 32, wherein the text relating to one particular varying levels of examination is differentiated from text relating to another particular varying levels of examination.
